(19) United States
(12) Patent Application Publication
(10) Pub. No.: US 2002/0138353 A1
(43) Pub. Date: Sep. 26, 2002

(54) Method and system for analysis of database records having fields with sets

(76) Inventors: Zvi Schreiber, (US); Amit Gal, (US)

Correspondence Address: MORGAN LEWIS & BOCKIUS LLP, 1111 PENNSYLVANIA AVENUE NW, WASHINGTON, DC, 20004, US

(21) Appl. No.: 09/796,718

(22) Filed: Mar. 2, 2001

Related U.S. Application Data
(63) Continuation-in-part of application No. 09/564,164, filed on May 3, 2000.

(51) Int. Cl. G06F 17/60; G06F 17/30

(52) U.S. Cl. 705/26; 707/1

(57) ABSTRACT

A method for analyzing a plurality of sets of elements, and determining which sets from among the plurality of sets have elements in common with a trial set, including arranging a stored plurality of sets according to a directed graph data structure, the directed graph including nodes that correspond to sets and including directed edges that correspond to a relationship of set-wise inclusion, for a given trial set, denoted T, finding, within the directed graph, a smallest set, denoted S, that contains T, and determining whether T has a non-empty intersection with sets of the directed graph that are contained within S. A system is also described and claimed.

### CROSS-RELATED APPLICATIONS

The application is a continuation-in-part of U.S. patent application Ser. No. 09/564,164 entitled “Apparatus, System and Method for Managing Transaction Profiles representing Different Levels of Market Party Commitment” filed on May 3, 2000.

### FIELD OF THE INVENTION

The present invention relates to databases that store records having multi-valued fields; i.e., fields with sets rather than single values therein. The present invention can be applied to matching profiles of flexible data, specifically in relation to on-line goods exchanges between buyers and sellers and other involved parties.

### BACKGROUND OF THE INVENTION

Existing database systems are designed to store specific data records such as details of a purchase order or invoice. This is true not only of relational databases but also of other models such as hierarchical, network, object, XML and associative databases.

However, as computers start to be used in electronic commerce, it becomes necessary to store flexible data that represents a range or set of specific data records. For example, an offer to enter into a business-to-business transaction may have flexibility in terms of quantity, price, delivery dates and terms and occasionally the buyer or even seller may have some flexibility in terms of technical specifications as well. Such an offer is best represented as a set, which is often a Cartesian product of ranges or enumerations of data (e.g. price<$ 100, 10,000<quantity<11,000, color ε{red, green}).

One can set up a relational database table that has two fields, price-min and price-max, in order to represent a range in the price. However this requires custom coding of the insertion and querying of records to ensure that the contents of these fields are treated as a range and not as two unrelated values.

Current on-line Internet exchanges operate by enabling sellers of merchandise to list their wares and by enabling buyers to purchase the wares. Examples of exchanges are auction houses such as the familiar www.ebay.com, where sellers can post commodities and buyers can bid on them, and electronic marketplaces such as www.esteel.com.

These types of exchanges provide limited interaction between buyer and seller. There is no automated mechanism for matching buyers and sellers. A buyer can either purchase an item, or bid on it, and there is no flexibility on the seller side. Any additional interactions between a buyer and a seller typically must be carried out off-line.

There is thus a need for expanding conventional databases that typically include records having single-valued fields, to allow for multi-valued fields. Specifically, there is a need for management and operation of databases having records with fields that contain sets.

### SUMMARY OF THE INVENTION

Prior art databases, whether relational, object, associative or XML, store specific data and allow flexible queries such as SQL, where an SQL query is associated with the set of the records it matches. In business-to-business e-commerce in particular, but also in other applications, such as security profiles which record the totality of actions for which each of a plurality of users have privileges, it is important to store flexible data or sets; i.e., the set of transactions which meet designated requirements. The present invention relates to design and operation of databases in which both stored records and queries involve sets, and a reply to a query returns records with overlapping sets.

It is an object of the present invention to allow for the storing of flexible data according to a general scheme that does not require custom coding for each application. The flexible data is typically a Cartesian product of ranges, enumerations, or more general sets wherein each element of the Cartesian product is a specific data record, such as a commercial transaction that is being offered.

When storing specific data records, databases typically allow the records to be retrieved according to a query. A query may be thought of either as a filter for data records or equivalently as a set (often an infinite set) of data records where the database will output all stored data records which are also within the set specified by the query. In applications such as e-commerce, sellers may each offer ranges of transactions. When a buyer specifies a range of transactions of interest to him, he wants to search for sellers who have some overlap (i.e. non-empty set intersection) in ranges with his, since this means that there is at least one specific transaction which satisfies both buyer and seller needs.

It is therefore a further object of the invention to store sets (i.e., flexible data) in such a way that there can be provided a query function in which the query represents a set, T, and the result is a list of all stored sets which have non-empty set intersection with T.

To this end, the present invention provides several innovations, including

a directed acyclic graph data structure specifically suited to storing sets and to providing set-set queries;

a series of methods for storing flexible data in the form of Cartesian products of ranges and enumerations in a conventional (e.g. relational) database and for providing required set-set queries by implementing conversions to the queries and using a conventional query mechanism of the database; and

application of an indexing scheme referred to as a multi-dimensional binary tree to efficient set-set querying, which typically involves multiple inequality constraints that do not scale logarithmically with standard indexing schemes.

It will be appreciated that the application to negotiation in electronic commerce is only one application for the storage of sets for flexible data and set-set querying for non-empty intersections. An example of another type of application is one involving a data format for describing resources in a system, such as filenames or URLs. For such an application, flexible data can be used, for example, to store a privilege profile of all resources to which a given user is allowed access.

The term “field” as used throughout the present specification refers to a particular characteristic of an object. The term “record” as used throughout the present specification refers to a description of an object in terms of one or more fields. For example, the object may be a profile for a transaction, and a record may include fields for price, quantity and delivery date.

The present invention can be applied to matching of transaction descriptions, such as buyer and seller transaction descriptions. Each transaction description is specified by data for various parameters, such as quantity, price, delivery date, delivery location and other transaction characteristics. A parameter for a transaction description can assume one or more values. For example, price can be specified as a range of values, and delivery date can be specified as a range of dates. The present invention applies to matching; i.e., identification of transaction descriptions that are compatible with one another.

More specifically, in a preferred embodiment, the present invention stores a plurality of transaction descriptions and matches a given transaction description with the stored transaction descriptions, to determine which of the stored transaction descriptions are compatible with the given transaction description.

The term “transaction description” as used throughout the present specification refers to a description of a desired one or more transactions.

The present invention provides a method and system for storing and indexing transaction descriptions provided by buyers and sellers and additional involved parties, in order to match them. A buyer provides a description of the commodities he is interested in purchasing, along with payment terms, delivery requirements, and other relevant information. The description is based on parameters for each type of information. The description may include ranges of parameters, allowing for flexibility in one or more terms of the transaction. Similarly, a seller provides a description of the commodities he is interested in selling, with ranges for various parameters.

In a preferred embodiment, the present invention analyzes transaction descriptions from buyers, sellers and other involved parties, and determines transactions that satisfy the constraints of all parties involved, if such transactions exist. In an alternate embodiment, the present invention also serves as a search vehicle, enabling a buyer to search for sellers that can accommodate his requirements, and enabling a seller to search for buyers that can accommodate his requirements.

There is thus provided in accordance with a preferred embodiment of the present invention a method for analyzing a plurality of sets of elements, and identifying which sets from among the plurality of sets have elements in common with a trial set, including arranging a stored plurality of sets according to a directed graph data structure, the directed graph including nodes that correspond to sets and including directed edges that correspond to a relationship of set-wise inclusion, for a given trial set, denoted T, finding, within the directed graph, a smallest set, denoted S, that contains T, and determining whether T has a non-empty intersection with sets of the directed graph that are contained within S.

There is further provided in accordance with a preferred embodiment of the present invention a system for analyzing a plurality of sets of elements, and identifying which sets from among the plurality of sets have elements in common with a trial set, including a data manager arranging a stored plurality of sets according to a directed graph data structure, the directed graph including nodes that correspond to sets and including directed edges that correspond to a relationship of set-wise inclusion, a set analyzer finding, for a given trial set, denoted T, a smallest set, denoted S, within the directed graph that contains T, and determining whether T has a non-empty intersection with sets of the directed graph that are contained within S.

There is yet further provided in accordance with a preferred embodiment of the present invention a method for analyzing a plurality of transaction descriptions having parameters for describing at least one transaction, and determining which transaction descriptions from the plurality of transaction descriptions overlap with a trial transaction description, including storing a plurality of transaction descriptions having flexible parameters for commercial transactions, selecting a primary parameter from among the flexible parameters, organizing the stored plurality of transaction descriptions in terms of the primary parameter, for a given trial transaction description, denoted T, finding a primary subset of transaction descriptions from among the stored plurality of transaction descriptions that overlap with T with respect to values of the primary parameter; and identifying the transaction descriptions from among the primary subset of transaction descriptions that overlap with T.

There is moreover provided in accordance with a preferred embodiment of the present invention a system for analyzing a plurality of transaction descriptions having parameters for describing at least one transaction, and determining which transaction descriptions from the plurality of transaction descriptions overlap with a trial transaction description, including a memory storing a plurality of transaction descriptions having flexible parameters for commercial transactions, a parameter selector selecting a primary parameter from among the flexible parameters, a data manager organizing the stored plurality of transaction descriptions in terms of the primary parameter, and a transaction description analyzer finding, for a given trial transaction description, denoted T, a primary subset of transaction descriptions from among the stored plurality of transaction descriptions that overlap with T with respect to values of the primary parameter, and identifying the transaction descriptions from among the primary subset of transaction descriptions that overlap with T.

There is additionally provided in accordance with a preferred embodiment of the present invention a method for analyzing a plurality of transaction descriptions, including storing a plurality of sets, wherein the sets include data for transaction descriptions that describe at least one transaction, and the elements correspond to individual transactions, arranging the stored plurality of sets according to a directed graph data structure, the directed graph including nodes that correspond to sets and including directed edges that correspond to a relationship of set-wise inclusion, and applying a data locking mechanism to the nodes of the directed graph, for processes to lock and unlock data included within the nodes, wherein a lock on any ancestor of a node precedes a lock on the node itself.

There is further provided in accordance with a preferred embodiment of the present invention a system for analyzing a plurality of transaction descriptions, including a memory storing a plurality of sets, wherein the sets include data for transaction descriptions that describe at least one transaction, and the elements correspond to individual transactions, a data manager arranging the stored plurality of sets according to a directed graph data structure, the directed graph including nodes that correspond to sets and including directed edges that correspond to a relationship of set-wise inclusion, and a data locking mechanism enabling processes to lock and unlock data included within the nodes of the directed graph, wherein a lock on any ancestor of a node precedes a lock on the node itself.

There is yet further provided in accordance with a preferred embodiment of the present invention a method for analyzing database records, including providing a database for storing a plurality of records, at least one record having at least one field that contains sets of values, and for a given query that specifies at least one set of values corresponding to at least one field, identifying the records from among the plurality of records in the database whose fields contain sets that have non-empty intersection with corresponding sets in the query.

There is moreover provided in accordance with a preferred embodiment of the present invention a system for analyzing database records, including a database for storing a plurality of records, at least one record having at least one field that contains sets of values, and a query processor identifying, for a given query that specifies at least one set of values corresponding to at least one field, the records from among the plurality of records in the database whose fields contain sets that have non-empty intersection with corresponding sets in the query.

There is additionally provided in accordance with a preferred embodiment of the present invention a method for analyzing a plurality of transaction descriptions, including receiving a plurality of submitted user requests, wherein a user request includes a request type, a request owner, and a transaction description having flexible parameters and corresponding to a set of individual transactions, and storing the user requests according to a directed graph data structure, the directed graph including nodes that correspond to user requests and including directed edges that correspond to a relationship of set-wise inclusion.

There is further provided in accordance with a preferred embodiment of the present invention a system for analyzing a plurality of transaction descriptions, including a user interface receiving a plurality of submitted user requests, wherein a user request includes a request type, a request owner, and a transaction description having flexible parameters and corresponding to a set of individual transactions, and a data organizer storing the user requests according to a directed graph data structure, the directed graph including nodes that correspond to user requests and including directed edges that correspond to a relationship of set-wise inclusion.

### BRIEF DESCRIPTION OF THE DRAWINGS

The present invention will be more fully understood and appreciated from the following detailed description, taken in conjunction with the drawings in which:

FIG. 1 is a simplified block diagram of a client server transaction exchange system in accordance with a preferred embodiment of the present invention;

FIG. 2 is a pictorial illustration of the intersection of a buyer and seller transaction description;

FIG. 3 is a simplified illustration of a directed acyclic graph used in a preferred embodiment of the present invention;

FIG. 4 is a simplified illustration of deletion of a node having a single parent node from a directed acyclic graph, in accordance with a preferred embodiment of the present invention;

FIG. 5 is a simplified illustration of insertion of a node into a directed acyclic graph, in accordance with a preferred embodiment of the present invention;

FIGS. 6A and 6B are simplified drawings illustrating the inclusion of artificial nodes in order to reduce the number of branches stemming from a node in a directed acyclic graph, in accordance with a preferred embodiment of the present invention;

FIG. 7 is a simplified illustration indicating a cube-like nature of a directed cyclic graph in accordance with a preferred embodiment of the present invention;

FIG. 8A is a simplified representation of indexing using a one-dimensional partition of a cube;

FIG. 8B is a simplified representation of indexing using a two-dimensional partition of a cube;

FIG. 9A is an illustration of a chained binary search tree for two-dimensional indexing;

FIG. 9B is an illustration of a two-dimensional binary search tree, in accordance with a preferred embodiment of the present invention;

FIGS. 10A-10C are a simplified flowchart of a procedure for deleting a node in accordance with a preferred embodiment of the present invention;

FIG. 11 is a simplified flowchart of a procedure for deleting an expired node in accordance with a preferred embodiment of the present invention;

FIG. 12 is a simplified flowchart of a procedure for destroying a node in accordance with a preferred embodiment of the present invention;

FIG. 13 is a simplified flowchart of a procedure for destroying a request ID in accordance with a preferred embodiment of the present invention;

FIGS. 14A-14D are a simplified flowchart of a procedure for adding a node in accordance with a preferred embodiment of the present invention;

FIGS. 15A and 15B are a simplified flowchart of a procedure for reading an XPL in accordance with a preferred embodiment of the present invention;

FIG. 16 is a simplified flowchart of a procedure for adding a request in accordance with a preferred embodiment of the present invention; and

FIG. 17 is a simplified flowchart of a procedure for clearing offers in accordance with a preferred embodiment of the present invention.

### LIST OF APPENDICES

Appendix A is a sample XPL document representing a buyer transaction description.

### DETAILED DESCRIPTION OF A PREFERRED EMBODIMENT

The present invention relates to databases that store records having multi-valued fields; i.e., fields with sets rather than single values therein. In business-to-business e-commerce in particular, but also in other applications, such as security profiles which record the totality of actions for which each of a plurality of users have privileges, it is important to store flexible data or sets; i.e., the set of transactions which meet designated requirements. The present invention relates to design and operation of databases in which both stored records and queries involve sets, and a reply to a query returns records with overlapping sets.

The present invention enables storing of flexible data according to a general mechanism that does not require custom coding for each application. The flexible data is typically a Cartesian product of ranges, enumerations, or more general sets wherein each element of the Cartesian product is a specific data record, such as a commercial transaction that is being offered.

The present invention can be applied to matching of transaction descriptions, such as buyer and seller transaction descriptions. Each transaction description is specified by data for various parameters, such as quantity, price, delivery date, delivery location and other transaction characteristics. A parameter for a transaction description can assume one or more values. For example, price can be specified as a range of values, and delivery date can be specified as a range of dates. The present invention concerns matching; i.e., determination of transaction descriptions that are compatible with one another.

More specifically, the present invention stores a plurality of transaction descriptions, and matches a given transaction description with the stored transaction descriptions, to determine which of the stored transaction descriptions are compatible with the given transaction description. The term “transaction description” as used herein refers to a description of a desired one or more transactions.

As the number of stored transaction descriptions grows, the task of matching can become formidable. In order to efficiently carry out a matching analysis, it is important to choose good internal and external data structures for representing transactions and transaction descriptions. In a preferred embodiment, the present invention uses an XML-based representation as an external data structure. The preferred embodiment described herein introduces an extensible profile language, referred to as XPL and described hereinbelow, to extend XML so as to allow for flexible parameters within XML tags. The use of XPL is advantageous in that it applies to any XML schema, thereby enabling description of sets of valid documents. XPL is also convenient for use in conjunction with a simple user interface, based on HTML or XML, which enables a user to set parameters for his transaction description and enter them within the system of the present invention.

In a preferred embodiment, the present invention uses a directed acyclic graph (DAG) for an internal data representation of stored transaction descriptions, based on a semi-lattice of sets of transactions, as described hereinbelow. A DAG consists of nodes and directed edges therebetween, and contains no (closed) cycles. In the preferred embodiment, the nodes of the DAG represent transaction descriptions. More specifically, the nodes of the DAG include data for transaction descriptions; namely, data for the flexible parameters for transactions. The nodes of the DAG can be considered as sets, based on transaction descriptions considered as being comprised of one or more individual transactions, as described hereinbelow. The edges of the DAG are directed from nodes (i.e., sets of transactions) to subsets thereof. Use of a DAG in the preferred embodiment reduces the number of comparisons necessary in order to identify stored transaction descriptions that are compatible with a given transaction description.

In an alternate embodiment of the present invention, stored transaction descriptions are represented internally as records within a database. Data for flexible parameters of the transaction descriptions is stored as fields within the individual records of the database. In the alternate embodiment, a database is employed with efficient indexing, so as to reduce the number of comparisons necessary in order to identify stored transaction descriptions that are compatible with a given transaction description. Specifically, binary search trees or hash tables are employed to bin records (i.e., stored transaction descriptions) relative to one or more fields (i.e., transaction parameters), as described hereinbelow, resulting in rapid identification of potential stored transaction descriptions for consideration as candidates for comparison with a given transaction description. This alternate embodiment can store records that correspond to sets that are Cartesian products and records that do not so correspond.

The present invention provides a method and system for matching buyers and sellers and additional involved parties within a commodity exchange, based on analysis of transaction descriptions provided by each individual. A buyer provides a description of commodities he is interested in purchasing, along with payment terms, delivery requirements, and other relevant information. The description is based on parameters for each type of information. For example, Table I indicates parameters for a buyer named Auto Industries, within an exchange for automobiles.

TABLE I
Buyer Transaction Description

| Parameter | Sub-parameters | | Value(s) |
|---|---|---|---|
| Make | | | Ford or Chevrolet |
| Model | | | 1998, 1999 or 2000 |
| Color | | | Black or Blue |
| Price | | | At most $15,000 |
| Delivery | | | November 1-15, 2000 |
| Payment terms | | | At most 50% upon |
| | | | delivery; the balance within |
| | | | at least 30 days of delivery |
| Parties | Buyer | Name | Auto Industries |
| | | State | CA |
| | Seller | Name | Any seller |
| | | State | CA |

Similarly, a seller provides a description of commodities he is interested in selling. For example, Table II indicates parameters for a seller named Cars, Inc., within the exchange for automobiles.

TABLE II
Seller Transaction Description

| Parameter | Sub-parameter | | Value(s) |
|---|---|---|---|
| Make | | | Ford |
| Model | | | 1998 |
| Color | | | Blue |
| Price | | | At least $13,000 |
| Delivery | | | October 25, 2000- |
| | | | November 5, 2000 |
| Payment terms | | | At least 40% upon delivery; |
| | | | the balance within at most |
| | | | 60 days of delivery |
| Parties | Buyer | Name | Any buyer |
| | | State | CA |
| | Seller | Name | Cars, Inc. |
| | | State | CA |

As can be seen, the buyer and seller each effectively describe a plurality of transactions, where an individual transaction corresponds to a single value of each parameter. In the case of the examples above, it can be seen that the buyer and seller descriptions overlap. For example, Table III indicates parameters for a transaction that satisfies both the buyer's and the seller's description.

TABLE III
Acceptable Transaction to Buyer and Seller

| Parameter | Sub-parameter | | Value(s) |
|---|---|---|---|
| Make | | | Ford |
| Model | | | 1998 |
| Color | | | Blue |
| Price | | | $13,000 |
| Delivery | | | November 1, 2000 |
| Payment terms | | | 50% upon delivery; |
| | | | 50% within 30 days |
| | | | of delivery |
| Parties | Buyer | Name | Auto Industries |
| | | State | CA |
| | Seller | Name | Cars, Inc. |
| | | State | CA |

This transaction can thus be cleared with the buyer, Auto Industries, and the seller, Cars, Inc.

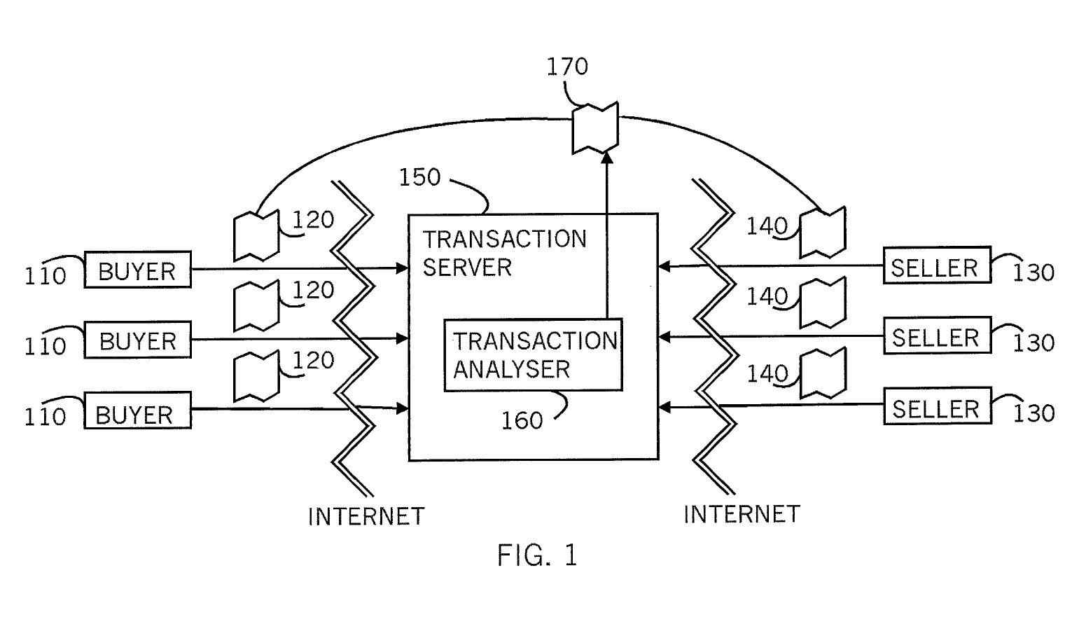

Reference is now made to FIG. 1, which is a simplified block diagram of a client server transaction exchange system in accordance with a preferred embodiment of the present invention. Multiple buyers 110 submit buyer transaction descriptions 120, and multiple sellers 130 submit seller transaction descriptions 140. The various transaction descriptions are uploaded to a transaction server 150 and analyzed by a transaction analyzer 160. Transaction analyzer 160 determines transactions 170 that meet the requirements of a buyer and a seller, as described in more detail with reference to FIG. 3 hereinbelow.

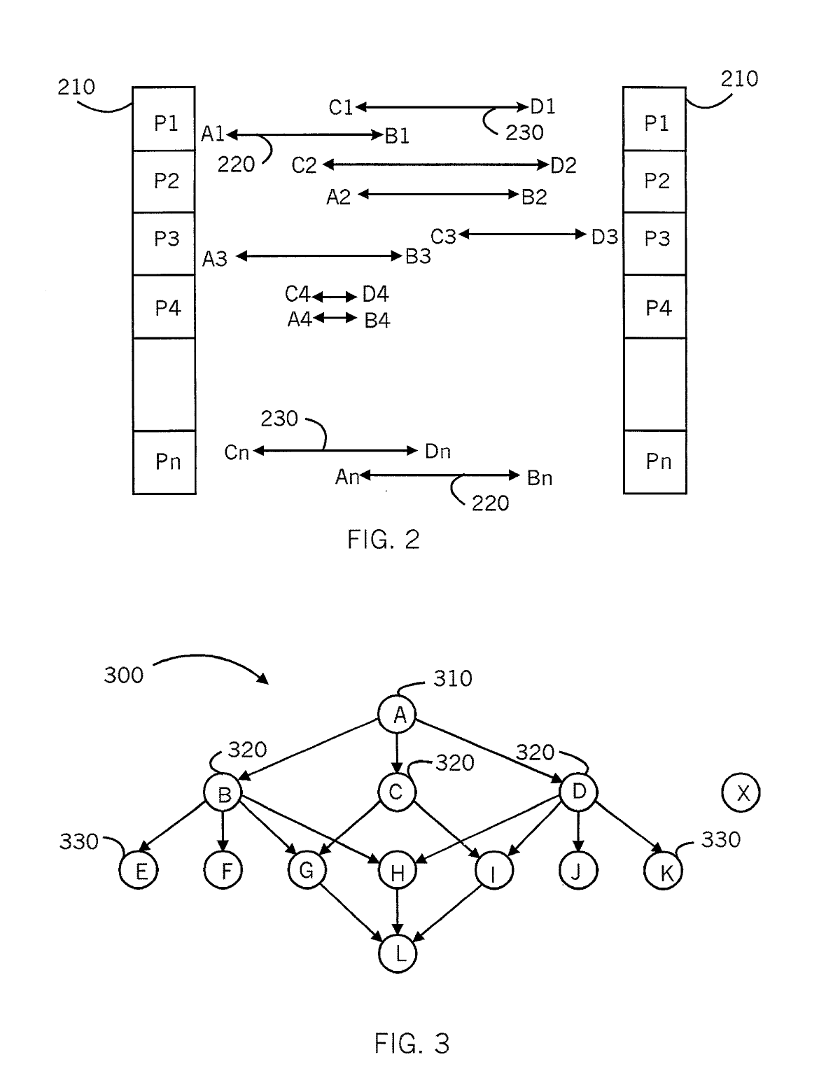

Reference is now made to FIG. 2, which is a pictorial illustration of the intersection of a buyer and seller transaction description in accordance with a preferred embodiment of the present invention. A buyer and a seller each specify one or more acceptable values for a set 110 of parameters. The specified values may be a finite set of discrete values or a continuous range of values. The buyer's values for a particular parameter Pi are indicated by a line segment 120 denoted AᵢBᵢ, and the seller's values are indicated by a line segment 130 denoted CᵢDᵢ. In order for there to exist parameter values that satisfy both the buyer's and the seller's requirements, each of the segments AᵢBᵢ and CᵢDᵢ must overlap. As can be seen in FIG. 1, although the buyer and seller segments for parameters P₁, P₂, P₄ and Pₙ do overlap, nevertheless the buyer and seller segments A₃B₃ and C₃D₃ do not overlap. Thus, for this example, there is no combination of parameter values for a transaction that can satisfy both the buyer and the seller.

In order to conduct an analysis of transaction descriptions so as to determine the existence of transactions that satisfy the requirements of a buyer and a seller, and additional involved parties, the present invention preferably uses a data structure to organize the transaction descriptions resident in transaction server 150 in such a way that it is efficient to analyze a new transaction description relative to transaction descriptions that already reside in transaction server 150.

Reference is now made to FIG. 3, which is a simplified illustration of a directed acyclic graph (DAG) used in a preferred embodiment of the present invention. “Directed” refers to the edges being directional, and “acyclic” refers to the non-existence of cycles; i.e., the non-existence of a path of directional edges starting at a node and leading back directionally to the same node.

Where a directed edge goes from a node A to a node B, node A is referred to as a “parent” of node B, and node B is referred to as a “child” of node A. For example, in FIG. 3, node C is a parent of node G, and node L is a child of node G.

A transaction description is equivalent to a set of parameter values and, for purposes of clarification, FIGS. 3-5 are described with reference to such sets, rather than with reference to transaction descriptions per se. In order for two transaction descriptions to overlap, so that there exists a transaction that satisfies both descriptions, the corresponding sets of parameter values must have a non-empty intersection. Thus, in a preferred embodiment, the present invention analyzes sets of parameter values to determine pairs of sets with non-empty intersection.

The sets of parameter values resident in transaction server 150 are arranged in the form of a DAG 300, in which the nodes 310, 320 and 330 represent sets of parameter values corresponding to transaction descriptions. The DAG is constructed so that no two distinct nodes correspond to the same set of parameter values. Edges run directionally from sets A to certain sets B contained within set A. Specifically, a directed edge runs from a set A to a set B whenever A contains B but there is no intervening set C strictly between A and B. Referring to FIG. 3, there is an edge from set A to set C, but not from set A to set I, even though A contains I, since C is an intervening set between A and I. Since each edge points from a larger set to a smaller set, it is clear that there cannot be a path of edges that starts and ends at the same node, and thus the resulting graph is acyclic.

Each DAG is supplied with a root note 310 containing a universal set for all possible parameter values. This set is a superset of any other set in the DAG. Additionally, each DAG is augmented with all non-empty intersections S₁∩S₂, of sets S₁ and S₂ in the DAG. This ensures that the DAG obeys a “closure” property, whereby the non-empty intersection of any two sets in the DAG is itself a set in the DAG. It can thus be seen that each set in the DAG is either the root set, one of the transaction descriptions sets, or a finite intersection of the transaction description sets. The sets in the DAG, together with the operation of intersection, comprise a mathematical structure referred to as a semilattice. A reference on semilattices is S. MacLane and G. Birkhoff, “Algebra,” The Macmillan Company, 1967, pgs. 487 et seq.

In a preferred embodiment of the present invention, transaction descriptions are input to a DAG by users submitting requests having transaction descriptions. A user request includes an owner, which may be the user submitting the request or another designated entity. A user request is typically either a buyer request, a seller request or a request from an additional involved party, such as a shipper or an insurer. A user request may also include an expiration date. Requests are catalogued in a hash table by means of a request ID, and typically have an expiration date.

A request within the system of the present invention is removed either upon expiration or upon express removal by its owner or by a system administrator. Removal of a request involves removal of the node in the DAG corresponding to the request.

User requests are preferably of two types: searches and offers. Search requests are requests to identify transaction descriptions that are compatible with a submitted transaction description. Offers are requests having a commitment to an exchange deal if a compatible transaction description is available. Offers are also of two types: soft offers and hard offers. A soft offer is a request whereby the user submitting the request wishes to be notified when a compatible transaction description is identified. A hard offer is a request whereby the user instructs the system to automatically close an exchange deal when a compatible transaction description is identified.

User notification of results is preferably achieved on-line, if a user is submitting a new request, or by way of e-mail notification for owners of old requests.

Preferably, when a deal is automatically closed for hard offers, the present invention automatically clears the deal within the system. Specifically the system automatically updates or removes the nodes for the transaction descriptions involved in the deal, as appropriate. For example, if a seller's transaction description includes 10,000 units of a commodity and a buyer's transaction description includes 8,000 units, and if a deal is closed between them for a sale of 8,000 units, then the seller's transaction description is modified to show 2,000 units, and the buyer's transaction description is removed from the database.

User requests are described more fully with reference to Table VII hereinbelow.

In a preferred embodiment of the present invention, for each request present within a database of stored transaction descriptions, there is maintained a list of all transaction descriptions compatible therewith, in the form of a vector referred to as a results vector. As new requests enter the database, the results vectors are updated accordingly.

When a new user request including a transaction description enters transaction server 150, transaction analyzer 160 determines which of the transaction descriptions already resident in transaction server 150 intersect with that of the new request. By organizing the sets of parameters in the form of a DAG, it is easy to analyze a new set 340 of parameter values, X, relative to the sets in the DAG, as explained hereinbelow.

To analyze new set 340 of parameters, X, the present invention preferably traverses the DAG from the root downwards so as to find a smallest set in the DAG that contains X within it. The DAG will necessarily have a unique such smallest set, because of the closure property that ensures that if two sets in the DAG contain X then their intersection is also in the DAG. For example, in FIG. 3, suppose set D is the smallest set containing set X.

To determine sets in the DAG that overlap with X, the present invention preferably examines the intersection of X with each of the descendants of D; i.e., with nodes H, I, J and K in FIG. 3. Whenever there is a non-empty intersection between X and a child of D, then the transaction description for X necessarily has a non-empty intersection with one or more of the transaction descriptions resident in transaction server 150. Specifically, suppose a child, I, of D corresponds to a finite intersection of transaction description sets TD₁∩TD₂∩TD₃. If X has non-empty intersection with I, then it necessarily has non-empty intersection with each of the transaction description sets TD₁, TD₂ and TD₃. Moreover, the intersections X∩TDᵢ comprise those transactions that are mutually compatible with both transaction descriptions X and TDᵢ.

In general, buyer transaction descriptions include a parameter identifying a unique buyer, and seller transaction descriptions include a parameter identifying a unique seller. This ensures that transaction descriptions coming from two different buyers (or two different sellers) necessarily have empty intersection. As a consequence, this ensures that when a non-empty intersection X∩TDᵢ between two transaction description sets exists, then necessarily one of them is a buyer's description and the other is a seller's description.

In particular, using the present invention it is not necessary to separate buyer descriptions from seller descriptions within a DAG, in order to avoid matching multiple buyers or multiple sellers together. The present invention automatically ensures that such matching is avoided, and all of the transaction descriptions can thus be treated homogeneously as a single pool of generic sets of parameters.

In a preferred embodiment of the present invention, if an overlapping transaction description with X is found, say, transaction description TDᵢ, then the transaction may be cleared, and the node for the overlapping transaction description TDᵢ may be removed from the DAG. However, note that the node for TDᵢ cannot be removed if TDᵢ has more than one parent node in the DAG, since in such a case TDᵢ is the intersection of its parent nodes and must be preserved in accordance with the “closure” property described hereinabove.

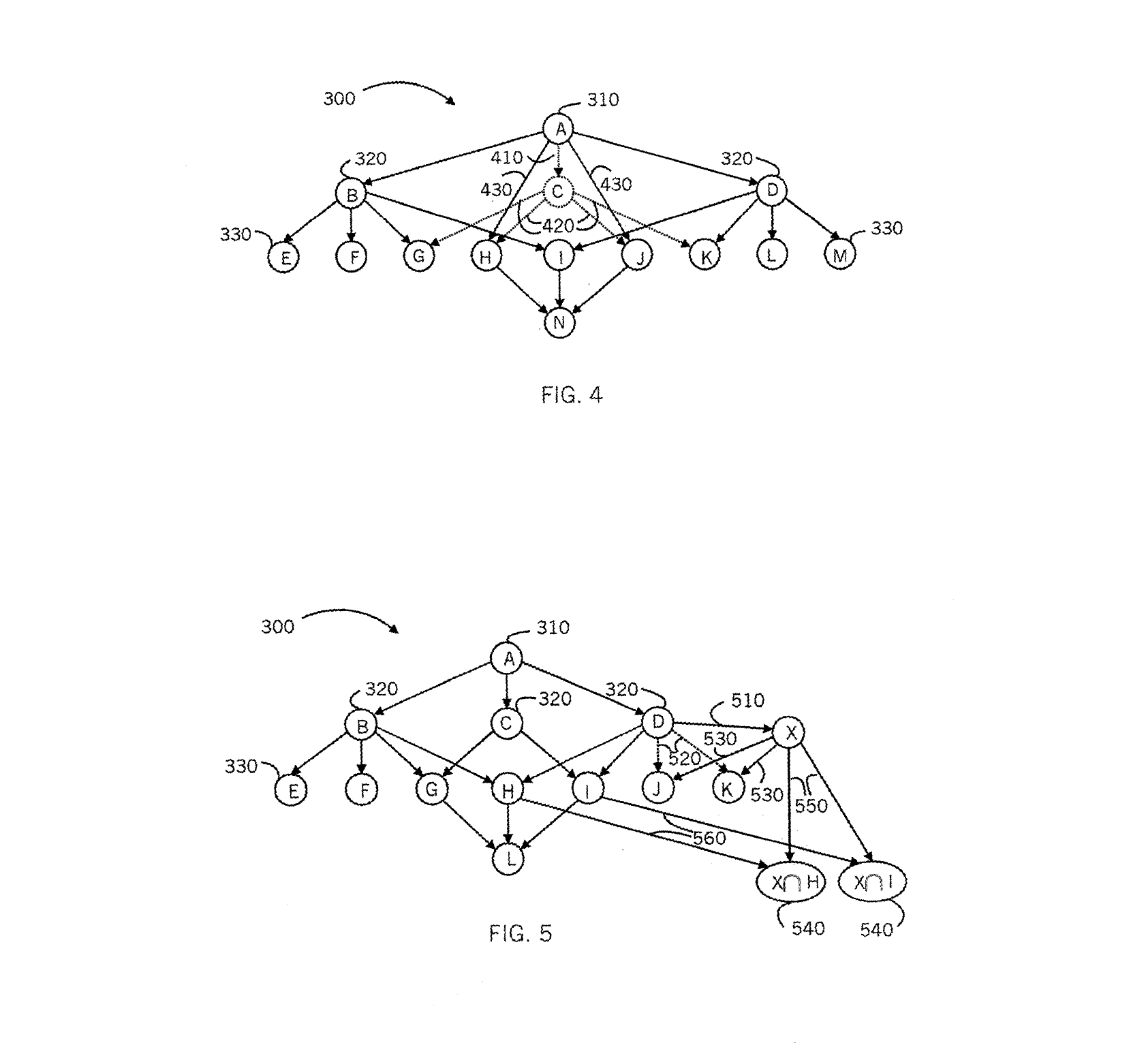

Reference is now made to FIG. 4, which is a simplified illustration of deletion (i.e., removal) of a node having a single parent node from a directed acyclic graph, in accordance with a preferred embodiment of the present invention. FIG. 4 illustrates deletion of node C from the DAG. The node C and the edge 410 leading to C and the edges 420 leading from C are deleted, and new edges 430 leading from the parent of C, namely, node A, to those children of C that are not children of any other child of A are added. Specifically, new edges 430 are added from A to H and from A to J, since H and J are not children of any child of A other than C. However, new edges are not added from A to G, since G is a child of B. Similarly, new edges are not added from A to K, since K is a child of D.

Conversely, in a preferred embodiment of the present invention, if an overlapping transaction description with X is not found, then a node for X is added to the DAG. Reference is now made to FIG. 5, which is a simplified illustration of insertion of a new node into a directed acyclic graph, in accordance with a preferred embodiment of the present invention. When adding X to the DAG, it is preferably positioned directly beneath the set D described above with reference to FIG. 3; namely, the smallest set in the DAG that contains X.

A new edge 510 is added from D to X. The children of D are analyzed to determine which ones are subsets of X. For those children that are subsets of X, the edges 520 from D to such children are deleted, and new edges 530 are added from X to such children. FIG. 5 indicates that J and K are children of D that are also contained within X. The edges 520 from D to J and from D to K are deleted, and new edges 530 are added from X to J and from X to K in their stead.

For those children of D that are not subsets of X, the intersections 540 of such children with X are added as new nodes, provided the intersections are non-empty. FIG. 5 indicates that the intersections X∩H and X∩I are added as new nodes. In addition, new edges 550 from X to such intersections and new edges 560 from such children to such intersections are preferably added. With reference to FIG. 5, new edges 550 are preferably added from X to X∩H and from X to X∩I, and new edges 560 are preferably added from H to X∩H and from I to X∩I.

It may be appreciated by those skilled in the art that, for purposes of efficiency in searching, it is typically preferred that the number of child notes descending from a parent node in the DAG not be large. In case the number of child nodes descending from a parent node is large, the present invention preferably introduces artificial nodes to represent combinations of such child notes, within an intermediate level of the DAG, between the parent node and the child notes, in order to reduce the number of branches coming out from the parent node.

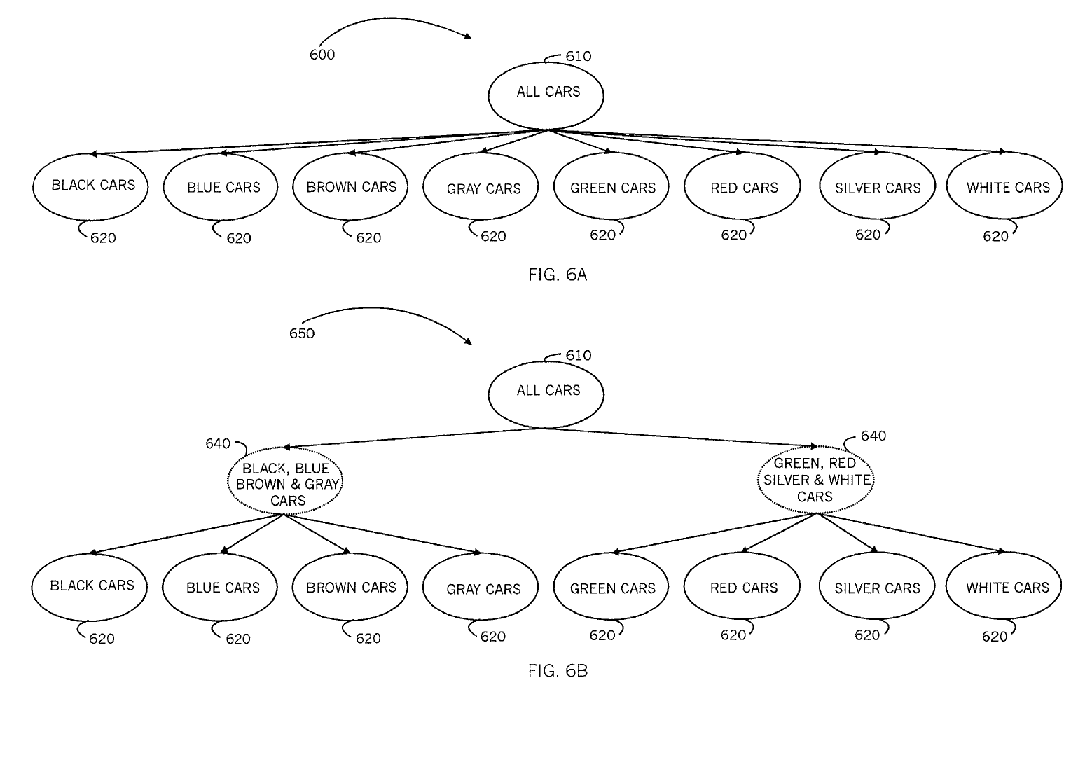

Reference is now made to FIGS. 6A and 6B, which are simplified drawings illustrating the inclusion of artificial nodes in order to reduce the number of branches stemming from a node in a directed acyclic graph, in accordance with a preferred embodiment of the present invention. Shown in FIG. 6A is a DAG 600 having a root node 610 representing the set of all transactions involving cars, and descending from root node 610 are eight child nodes 620 representing the set of all transactions involving black cars, blue cars, brown cars, green cars, gray cars, red cars, silver cars and white cars.

In order to reduce the number of branches stemming from root node 610, two artificial nodes 640 are added between the parent node and the child nodes in the DAG 650 shown in FIG. 6B. One artificial node 640 represents the colors black, blue, brown and green, and the second artificial node 640 represents the colors gray, red, silver and white. In this way DAG 600 is modified from a DAG having eight child nodes descending from its root node 610, to a DAG 650 having two artificial child notes 640 descending from its root 610, and four child nodes 620 descending from each of the two artificial nodes 640.

It may thus be appreciated that there are typically several types of nodes present in a DAG, including (i) nodes originating from user requests, (ii) artificial nodes as illustrated in FIG. 6, (iii) a root node, and (iv) nodes that are intersections of user requests, included in the DAG in conformance with the closure property that the DAG be closed under intersection, as described hereinabove. The first type of node, namely, nodes originating from user requests, are referred to as “reportable nodes,” since information is reported to the owners of such requests.

The information reported for reportable nodes includes a list of other reportable nodes that are compatible therewith. Such a list is referred to as a results vector, as mentioned hereinabove. The results vector for a reportable node is initially generated when the corresponding request first enters the database of the present invention. Thereafter the results vector for the node is updated as additional compatible requests enter the database. Specifically, when a new request including a transaction description enters the database, a search is made for transaction descriptions within the database that are compatible with the newly entered transaction description. The compatible transaction descriptions identified in the database are inserted into the results vector for the newly entered transaction description. Correspondingly, the new transaction description is added to the results vectors for each of the identified transaction descriptions that are compatible therewith. In this way, the results vectors for all reportable nodes are maintained current.

Preferably, when transactions are cleared between two or more user requests, the user requests are modified accordingly, as described hereinabove.

Preferably, results vectors are updated when new requests are submitted into the database, when existing requests expire or are withdrawn, and when existing user requests are modified. User requests are modified when transactions are automatically cleared, and when owners of requests modify them directly.

Results vectors for reportable nodes are conveyed to owners of the corresponding requests, either by on-line notification or by e-mail. Notifications are updated periodically, either whenever the results vectors are changed, or according to a preset notification schedule.

The sets corresponding to nodes in a DAG are often Cartesian products of the individual sets of values for each parameter, although this is not necessary since the parameters in a transaction description may have inter-dependencies. If a transaction description TD specifies values of parameter P₁ ranging in a set A₁, values of parameter P₂ ranging in a set A₂, etc., then typically the set of parameter values corresponding to TD is the Cartesian product A₁×A₂ × . . . ×Aₙ.

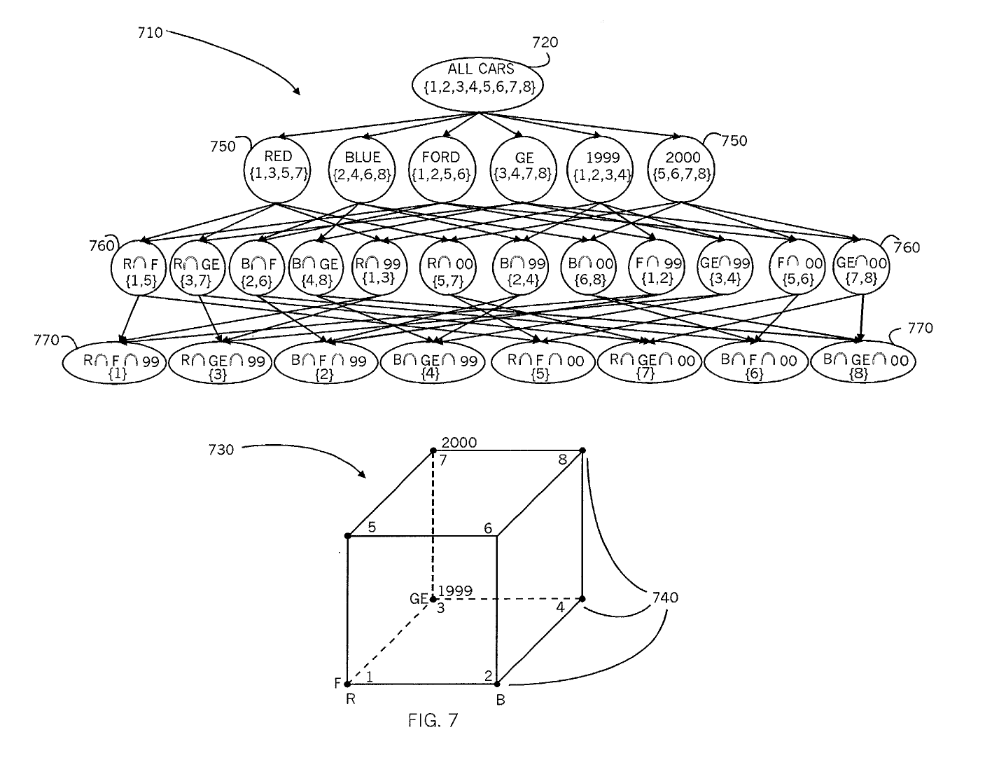

Reference is now made to FIG. 7, which is a simplified illustration indicating a cube-like nature of a directed cyclic graph in accordance with a preferred embodiment of the present invention. Shown in FIG. 7 is a DAG 710 for transaction descriptions involving automobiles, with three parameters, as indicated in Table IV.

TABLE IV
Parameters for Automobile Transactions

| Parameter | Possible Value |
|---|---|
| Make | Ford or GE |
| Color | Red or Blue |
| Year | 1999 or 2000 |

DAG 710 includes a root node 720 corresponding to all cars, and descendent nodes corresponding to each combination of parameter values.

Also shown in FIG. 7 is a three-dimensional cube 730 with axes representing each of the parameters: make, color and year. Vertices 740 of cube 730 define a single set of parameters, and thus correspond to a single transaction. For example, vertex 1 corresponds to a 1999 red Ford, and vertex 2 corresponds to a 1999 blue Ford.

Each of the sets in DAG 710 corresponds to a set of vertices of cube 730, as indicated in FIG. 7. It can be readily seen that root node 720 corresponds to the set of all vertices of cube 730, (ii) sets 750 correspond to each of the six faces of cube 730, (iii) sets 760 correspond to each of the twelve edges of cube 730, and (iv) sets 770 correspond to each of the eight vertices of cube 730.

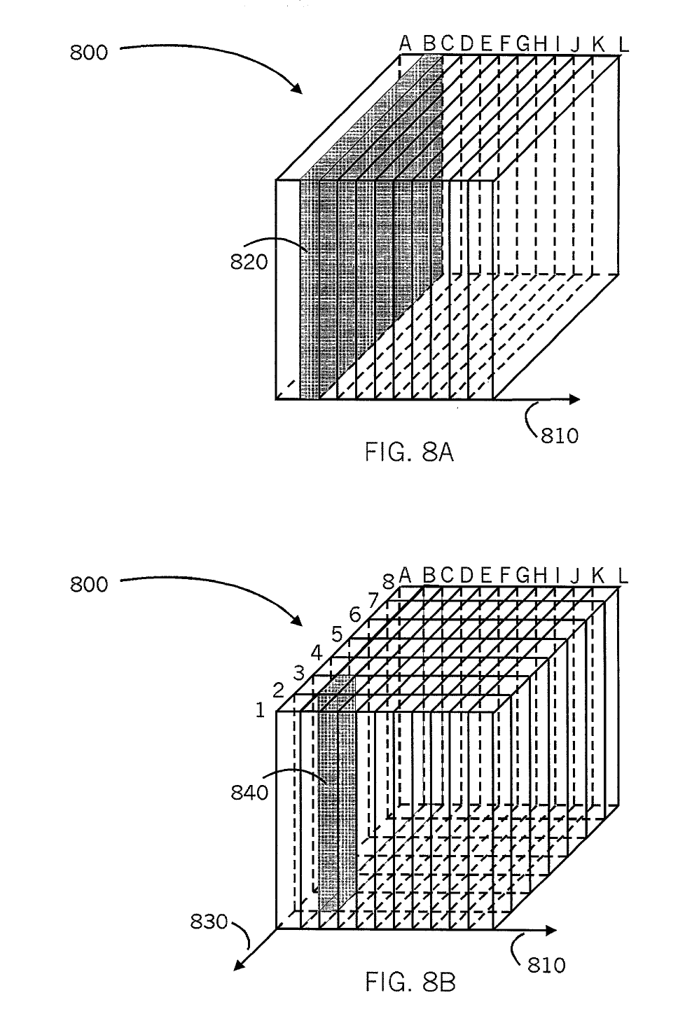

An alternative embodiment of the present invention can be described using the cube-like representation of the DAG. Reference is now made to FIG. 8A, which is a simplified representation of indexing using a one-dimensional partition of a cube 800. Cube 800 represents the set of all possible transactions. Individual transactions correspond to points within cube 800, and transaction descriptions correspond to subsets of cube 800.

By partitioning one of the axes, 810, it is possible to bin transactions according to values of a parameter represented by axis 810. Specifically, a partition of axis 810 induces a partition of cube 800 into planar slabs, such as shaded planar slab 820 situated between B and C. For example, if axis 810 represents a color parameter for a car, then axis 810 can be partitioned into red, blue, green, black and white; and this induces a corresponding partition of cube 800 into red cars, blue cars, green cars, black cars and white cars.

Partitioning the set of all transactions using one of the parameters as index simplifies the process of determining which transaction descriptions in transaction server 150 (FIG. 1) overlap with a newly entered transaction description from a buyer or seller or other related third party. By sorting transactions according to a partitioned parameter, it is possible to eliminate transactions with values of such parameter that cannot overlap with the newly entered transaction description. For example, only those stored transaction descriptions specifying red cars need be considered as candidates for matching a buyer's transaction description expressing interest in purchasing a red car.

Reference is now made to FIG. 8B, which is a simplified representation of indexing using a two-dimensional partition of a cube. In FIG. 8B both axes 810 and 830 are partitioned, which induces a corresponding partition of cube 800 into vertical bars, such as shaded bar 840 situated between rows 2 and 3 and between columns B and C. For example, if axis 810 represents a color parameter, as above, and if axis 830 represents a year of manufacture, say, between 1995 and 2000, then the induced two-dimensional partition of cube 800 is red 1995 cars, red 1996 cars, red 1997 cars, . . . , red 2000 cars, blue 1995 cars, blue 1996 cars, . . . , blue 2000 cars, . . . , white 1995 cars, white 1996 cars, . . . and white 2000 cars.

Preferably, searching for items within a two-dimensional partition is carried out with two successive one-dimensional searches. The first search, along one of the axes of cube 800, leads to a specific planar slab, such as slab 820 (FIG. 8A). The second search, within the specific planar slab, leads to a specific bar, such as bar 840. The choice of which of the two axes 810 and 830 to use for the first search can often make a difference in performance, as discussed hereinbelow.

Parameters of a transaction description can be considered as record fields, for records within a database. As is well known in the art, single-index fields can be sorted according to a binary search tree data structure, to facilitate searching for records having specific values in specific fields. For example, if records for transactions related to cars are indexed by color, the records can be sorted according to a binary tree structure. For example, the records can be sorted alphabetically, so that the root contains all 26 letters (the A-Z colors); the two children underneath the root are the A-M colors and the N-Z colors; the two children of the A-K colors are the A-F colors and the G-M colors; the two children of the N-Z colors are the N-S colors and the T-Z, etc. The leaves at the bottom of the tree are the individual letter colors blue, brown, cyan, etc.

Using the above binary search tree, one can search for all transaction descriptions involving a specific color by traversing the tree. Traversal takes at most CEILING(log₂26)=5 compares. Generally, traversal of a tree with m colors takes at most CEILING(log₂ m) compares.

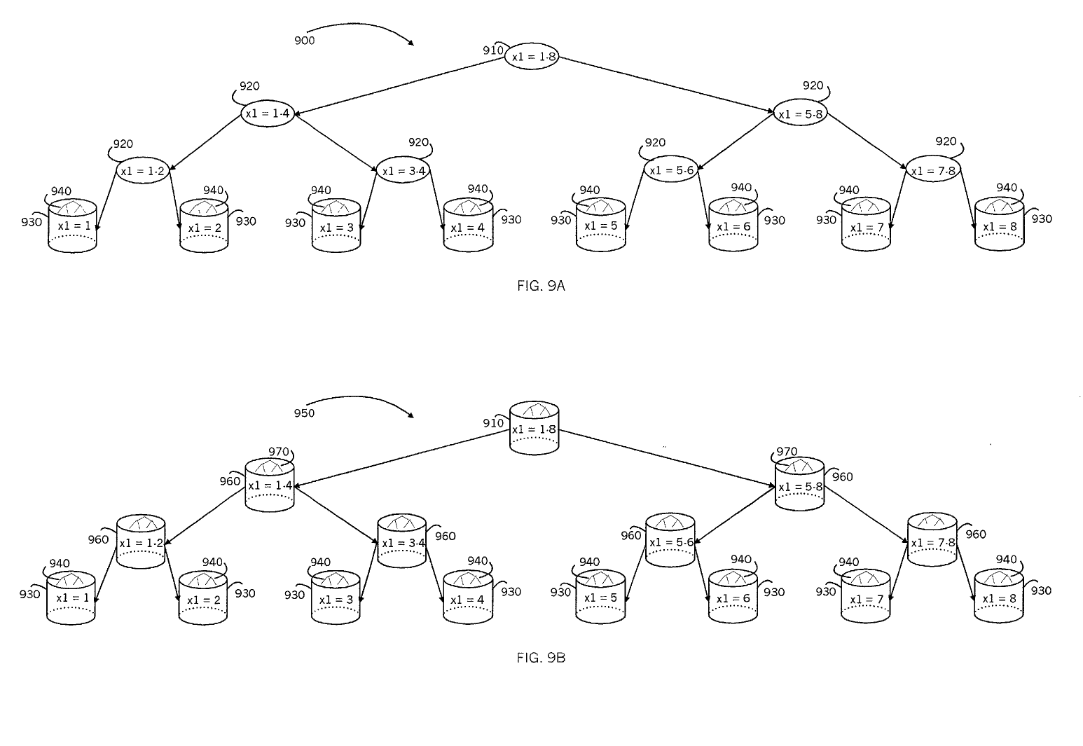

Reference is now made to FIG. 9A, which is an illustration of a chained binary search tree 900 for two-dimensional indexing. Specifically, for efficient implementation of searches for transaction descriptions based on values of indices x₁ and x₂ of two fields, it is convenient to bin stored transaction descriptions within a double-index tree data structure. Binary search tree 900 includes secondary trees indexed on x₂ within leaf nodes of a primary tree indexed on x₁, so that a search on x₂ is chained after a search on x₁, as described hereinbelow.

Referring to FIG. 9A, tree 900 is a binary search tree for an index x₁ that has eight possible values (1-8). A root node 910 contains the full range 1-8 for x₁. Intermediate nodes 920 contains partial ranges. The children of root node 910 are nodes 920 with ranges 1-4 and 5-8. The children of the node 920 with ranges 1-4 are nodes 920 with ranges 1-2 and 3-4. The leaf nodes 930 at the bottom contain transaction descriptions having specific values x₁=1, x₁=2, etc. Searching for all records having a specific value of x₁ takes at most CEILING(log₂8)=3 compares.

In a preferred embodiment of the present invention, in order to match an incoming transaction description with a totality of transaction descriptions stored within a database, the set of transaction descriptions in the database that need to be analyzed is reduced by limiting the analysis to those transaction descriptions that have the same parameter value as that of the incoming transaction description, for a selected parameter. Thus, for example, if the incoming transaction description has a parameter x₁=3, then only those transaction descriptions in the x₁=3 bin in FIG. 9A need to be analyzed.

In a preferred embodiment of the present invention, if a transaction description within the database specifies a plurality of values for x₁, then such transaction is binned in each of the corresponding x₁ bins. For example, if a transaction description within the database specifies that x₁ should be either 1 or 2, then such description is binned in both the x₁=1 bin and the x₁=2 bin.

Preferably, when using two indices x₁ and X₂ of two fields, in order to further limit the set of transaction descriptions that need to be analyzed to those that have the same x₁ and the same X₂ index values as does the incoming transaction description, a first search is made based on a first one of the indices, say x₁, to identify a specific x₁ bin, and then within the specific x₁ bin a second search is made based on the second one of the indices, say x₂, to identify a specific x₂ bin. Thus, for example, if the incoming transaction description has parameters x₁=3 and x₂=6, then a first search is made to locate the x₁=3 bin within tree 900, and then a second search is made within the x₁=3 bin to locate the x₂=6 bin therewithin. The second search is based on a binary search tree for X₂ located within the x₁=3 bin. Binary search trees for x₂ are indicated by numerals 940 in FIG. 9A, and they reside within leaf nodes 930 for each specific x₁ bin. Often the decision as to which indices to base a search on, and which index to use for the first, or primary, search, and which index to use for the second, or secondary search, has an impact on performance.

The use of XPL in the present invention enables parameters to take pluralities of values, such as values within ranges. Thus, for example, an incoming transaction description can specify that x₁ can be 1, 2 or 3, and that x₂ can be 6 or 7. This flexibility in parameters, while enabling transaction descriptions to be flexible, complicates the use of binary search trees. To match transaction descriptions within the database with an incoming transaction description having x₁ specified to be either 1, 2 or 3, and having x₂ specified to be either 6 or 7 would require analyzing the transaction descriptions resident in nodes 930 for the primary bins x₁=1, x₁=2 and x₁=3, and further within the secondary bins x₂=6 and x₂=7 within trees 940 of each of the three primary bins.

In business-to-business applications for which flexible profiles are stored, multiple inequalities arise often. For example, if an inequality x₁>A is stored, then even a simple query x₁=a becomes an inequality A<a, as described hereinbelow. It may be appreciated by those skilled in the art that a conventional branching index chain on parameters x₁ and x₂ cannot provide a fast answer to inequalities x₁>A & x₂>B. This is because a tree on x₁ only has bins at the leaves, and x₁>A returns many bins, each of which has to be searched separately for x₂>B. The present invention preferably uses a data structure that is not typically implemented within databases; namely, a “two-dimensional binary tree” as in FIG. 9B. A two-dimensional binary tree is a natural data structure to use for business-to-business e-commerce applications and, more generally, for managing databases with flexible data stored therewithin.

Two-dimensional binary search trees, like tree 950 in FIG. 9B, are used for indexing records according to two indices. Such binary search trees are described in Lueker, George S., A data structure for orthogonal range queries, Proceedings of the 19^{th} Annual IEEE Symposium on Foundations of Computer Science, 1978, pgs. 28-34. Lueker also describes algorithms for inserting, deleting and destroying nodes from such a binary tree. “Deleting” refers to deletion, or removal, of a single node, and “destruction” refers to deletion of a node and all of its descendents. For background on range queries, refer to Knuth, D., The Art of Computer Programming, Vol. 3: Sorting and Searching, Addison-Wesley, Reading, Mass., 1973, pgs. 554-555.

The two-dimensional binary tree includes secondary binary search trees within all nodes of a primary binary search tree. Reference is now made to FIG. 9B, which is an illustration of a two-dimensional binary search tree 950, in accordance with a preferred embodiment of the present invention. In addition to secondary search trees 940 residing within leaf nodes 930, two-dimensional binary search tree 950 includes additional secondary search trees 970 within root note 910 and intermediate nodes 960. Each secondary search tree within a node is a binary search tree relative to the index x₂, for all transaction descriptions having x₁ within the range corresponding to such node. Thus, for example, secondary search tree 970 included within intermediate node 960 having range x₁=5-8, is a binary search tree indexed by x₂, for all transaction descriptions in the database having x₁ within the range 5-8.

It can be appreciated by those skilled in the art that any set of values for x₁ is a disjoint union of at most 8/2=4 bins in FIG. 9B. Moreover, any interval range of values for x₁ is a disjoint union of at most CEILING(log₂8)=3 bins in FIG. 9B. (Observe that a range of values for x₁ does not require more than one bin per level of the tree.) Generally, for an m-valued index x₁, any interval range of values for x₁ is a disjoint union of at most CEILING(log₂ m) bins. After the bins for x₁ are determined, the secondary tree in each such bin is searched using the value(s) of x₂.

It may be appreciated that the two-dimensional tree structure illustrated in FIG. 9B requires more memory than the chained tree structure illustrated in FIG. 9A. Generally, if there are n transaction descriptions stored in the database, then FIG. 9A requires storage of n records, whereas FIG. 9B requires storage of n log₂ m records, where m is the number of distinct values for x₁, since all n records are stored in each level of tree 950 in FIG. 9B.

In a preferred embodiment of the present invention, some parameters are limited by interval range inequalities, and such inequalities are stored by storing parameters for endpoints of interval ranges. For example, an interval price range is specified by a first parameter for the lower bound of the range, and a second parameter for the upper bound of the range.

Preferably, when flexible records have inequalities of the same format for a parameter x, e.g., x<A, x>A or A<x<B, the delimiters A (and B) are stored as fields. Incoming queries are adapted to take into account that these fields represent limits, rather than fixed values, as per Table V hereinbelow.

Preferably, when there are mixed formats within different stored flexible records, including x=A, x<A and x>A, but no interval ranges with two limits, A is stored in one field, and a symbol “=”, “<” or “>” in another field. As above, queries are adapted accordingly. A standard database chained index scheme can be used effectively by indexing first on the symbol =/</> and subsequently on the value of A.

Preferably, when there are also interval ranges A<x<B, the above one-sided inequalities are converted into interval ranges by using special symbols for +/− infinity, and the delimiters A and B are stored in two separate fields.

Preferably, when there are discrete enumerations of different values for a parameter x, a list of possible values is stored in a helper table and the records are preferably indexed by listing each record under all relevant values.

In order to match incoming transaction descriptions with transaction descriptions residing within a database, it is necessary to use interval arithmetic in order to interpret the condition for a match. For example, suppose a transaction description in the database specifies an interval a<x<b for a price, x, using parameter a as the lower bound and b as the upper bound. Suppose further that an incoming transaction description specifies an interval x>A, for the same parameter, x, then the condition for a possible match is that A<b. I.e., in order for the two intervals, a<x<b and x>A to overlap, it is necessary and sufficient that A<b.

The following Table V summarizes the logic for the interval arithmetic necessary to analyze matches for transaction descriptions with range parameters.

TABLE V
Interval Arithmetic for Matching Transaction Descriptions

| | Incoming Transaction Description | | |
|---|---|---|---|
| Transaction | x < B | x > A | A < x < B |
| description | | | |
| with database | | | |
| | Condition for Overlapping Intervals | | |
| x < b | always | A < b | A < b |
| x > a | B > a | always | B > a |
| a < x < b | B > a | A < b | A < b and B > a |

By representing interval ranges as two fields for delimiters, and by using Table V to resolve queries with ranges, the present invention extends the conventional query mechanisms of databases with single-valued fields to set-set queries; i.e., to queries involving sets and records having fields with sets therein. Since ranges typically require two fields for delimiters, the use of two-dimensional binary trees is particularly well suited for set-set queries.

For example, if records in the database have a set-valued field with sets of the form a<x<b therein, and if a query is made for records within the database that overlap with the set 2<x<5, then this is converted to a conventional database query for records having single-valued fields for a and b that satisfy a<5 and b>2. In this framework, even a single-valued query such as x=2 is converted to a conventional database query for records satisfying a<2 and b>2.

It can thus be appreciated that the present invention provides a framework for management and operation of databases having records with set-valued fields. As distinct from conventional single-valued fields that store single values for parameters, the set-valued fields of the present invention store a plurality of values, such as an enumeration of values or a range of values. Records with set-valued fields correspond to sets of conventional records with single-valued fields; typically, to Cartesian products of conventional records, but also to more general sets if the sets in the fields have inter-relationships.

In the framework of the present invention, a database query can include set-valued fields and a reply to such a query provides a list of all records in the database that have non-empty intersection with the query.

Implementation Details

In a preferred embodiment of the present invention, specific transactions are represented as XML documents, and transaction descriptions are preferably represented as a derived form of XML referred to as XPL (“Extensible Profile Language”), which enables multiple values to be specified for parameters. Appendix A is a sample listing of a buyer transaction description using XPL syntax. Note is made of the standard well-formed XML style, together with special XPL entries used to specify multiple parameter values. For example,

the XPL identifier “choice” precedes a list of a finite set of choices for a specific parameter;

the XPL identifier “range” specifies an interval range, using values for “min” and “max”;

the XPL identifier “daterange” precedes two date specifications; and

the XPL identifier “any-element” allows for any XML element, which can include sub-elements.

XPL is a non-schema specific wild-card language for XML. One of the inherent advantages of XML is that it is a cross-industry standard. Thus the same software system can work across multiple industries.

In a preferred embodiment of the present invention, locks are used to control access to nodes in the DAG and their associated data. Preferably, two types of lock classes are used, as follows:

SimpleLock

A SimpleLock class implements a simple semaphore that can be owned by at most one thread. This class has a variable owner, which is either the ID of the thread that has the lock, or else is null when no thread has the lock. A synchronous method getLock( ) waits, by looping and sleeping, until the owner is null and then inserts its thread ID and returns. A method releaseLock( ) sets the owner back to null. A method verifyLock( ) returns if the thread has a lock and logs an error and throws an exception if it does not have a lock. A method checkLock( ) returns true if and only if the calling thread owns the lock.

ReadWriteLock

A ReadWriteLock class implements a lock for which at most one thread can own write permission, and if no thread has write permission then multiple threads can have read permission. This class preferably does not issue new read locks while any thread is waiting for a write lock. Preferably, this class includes methods getReadLock( ), getWriteLock( ), releaseReadLock( ) and releaseWriteLock( ).

In a preferred embodiment of the present invention, nodes are implemented as instances of a Java class named “node.” Preferably, the node Java class includes members listed below in Table VI.

TABLE VI
Structure of Node Class

| Member | Description |
|---|---|
| ReadWriteLock | To protect against deletion of the node |
| XPL | A document, represented as a tree of objects, each of |
| | which corresponds to an XML element |
| Calendar | Calendar class including an expiry date |
| Request ID list | A list of the request IDs which are included in the XPL |
| Children Vector | A vector of pointers to nodes, representing the children |
| | of a node in the DAG, and a ReadWriteLock to |
| | protect it |
| Parents Vector | A vector of pointers to nodes, representing the parents |
| | of a node in the DAG, and a ReadWriteLock to |
| | protect it |
| Next Pointer | A pointer (which may be a null pointer) to a node and |
| | a ReadWriteLock to protect it |
| Previous Pointer | A pointer (which may be a null pointer) to a node and |
| | a SimpleLock to protect it. |

The next and previous pointers are used to implement a linear ordering of the nodes in the DAG. Having a linear ordering is useful when there is a need to traverse all the nodes; for example, when the data in all of the nodes is to be adjusted. The DAG data structure is less efficient in this regard.

In addition, preferably a global ReadWriteLock protects the DAG data structure, for use by a backup procedure.

Preferably, the DAG data structure is initialized with a single special node, the “root” node, which has XPL<any_element/>, an empty parents vector, an empty children vector, a null previous pointer and a null next pointer.

Preferably, associated with the DAG data structure is a hash table that stores details of user requests, using a request ID as a key. Preferably, for each such request, the hash table contains fields listed below in Table VII.

TABLE VII
Structure of a User Request

| Field | Description |
|---|---|
| Node | A pointer to the node in the data structure |
| | that contains the XPL originating the request |
| Status | The status of the request (search/offer/ |
| | proposal) |
| ReadWriteLock | Protects against removal of the request from |
| | the data structure, and against changes to an |
| | “available” amount for an offer |
| Available | A record of the amount available for the |
| (used only if | request, which is initially equal to the |
| the request has | maximum of the <quantity> child, and which |
| status “offer”) | is decremented whenever a partial clearing |
| | occurs |
| Minimum | A record of a minimum transaction quantity |
| (used only if | for the request, which is equal to the |
| the request has | minimum attribute of the range under the |
| status “offer”) | <quantity> element of the XPL of the |
| | request |

In a preferred embodiment of the present invention, the following dynamic rules are obeyed:

No thread may change the children or parents vector of a node without a write lock.

No thread may read the children or parents vector of a node without a read lock.

No thread may change the previous pointer or next pointer of a node without a write lock.

No thread may read the previous pointer or next pointer of a node without a read lock.

No thread may remove a request from the hash table or change its available amount without a write lock.

No thread may remove a node from the DAG data structure without a write lock on the node, and on its parents vector and its children vector.

No thread may delete a node unless either it is destroying the node or else it has a read lock on every node in the node's request ID list.

No thread may make any change to the DAG data structure without a global read lock.

In a preferred embodiment of the present invention, there is a mechanism to ensure that there are no deadlocks in which each of two threads waits for a lock that the other thread obtained. In order to achieve this, a partial order is defined on the locks in the system, including locks associated with nodes that are not in the data DAG data structure, such as nodes that are being added or deleted, as follows:

The global lock precedes all other locks.

Hash table locks are ordered according to the request ID, using a string compare.

A lock on the parents vector of a node precedes a lock on the node, and a lock on a node precedes a lock on its children vector.

If node p is a subset of node q, then every lock on q precedes any lock on P.

Next and previous pointer locks follow the above rules. Specifically, after taking a previous lock of a node, the next lock of the node may be taken; and after taking a next lock of a node, the previous lock of the node it points to may be taken. Locks must be released in strict reverse order, so that a continuous chain of locks is maintained.

A thread may take locks on a node it has created, which no other thread knows about, regardless of the order.

Referring to FIG. 3, for example, a lock on A precedes a lock on C, a lock on C precedes a lock on G, and a lock on G precedes a lock on L. Any one thread that holds multiple locks simultaneously must have obtained the locks in strict order as above. Thus, for example, a thread may not have locks on two nodes p and q if neither one contains the other; and therefore locks will not be taken simultaneously on two or more children or on two or more parents of a node.

The following discussion provides preferred embodiments for procedures to (i) delete a node, (ii) delete an expired node, (iii) destroy a node, (iv) destroy a request ID, (v) add a node, (vi) read an XPL, (vii) add a request, and (viii) clear two offers.

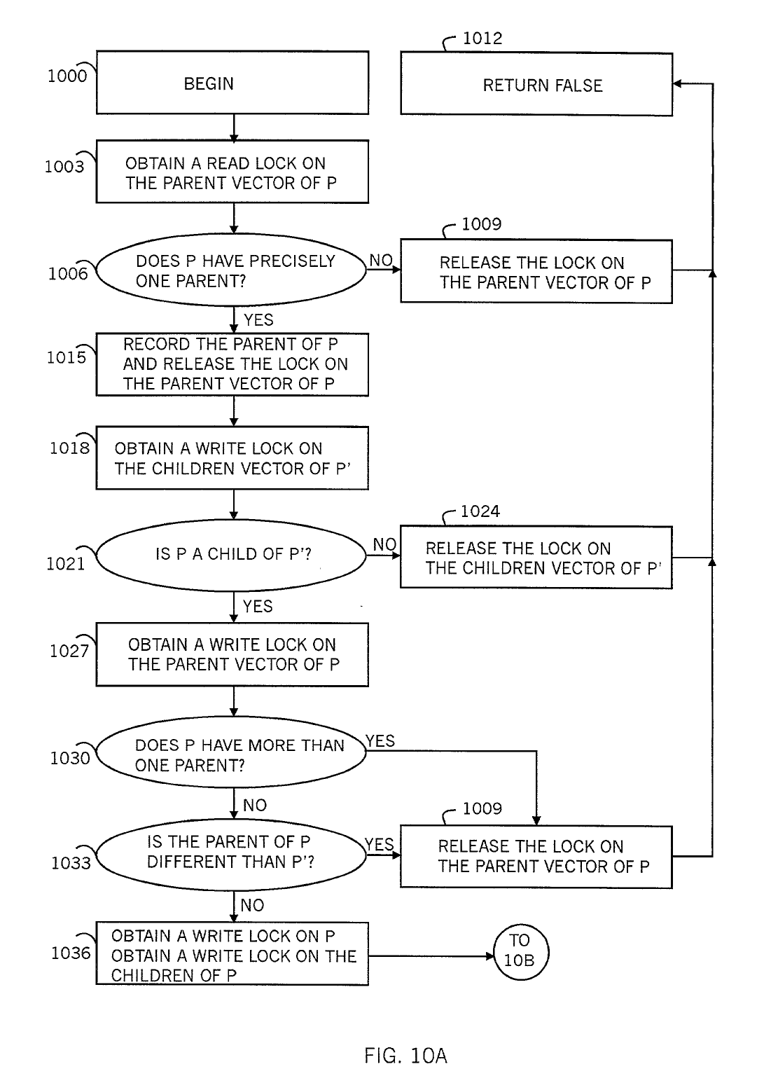

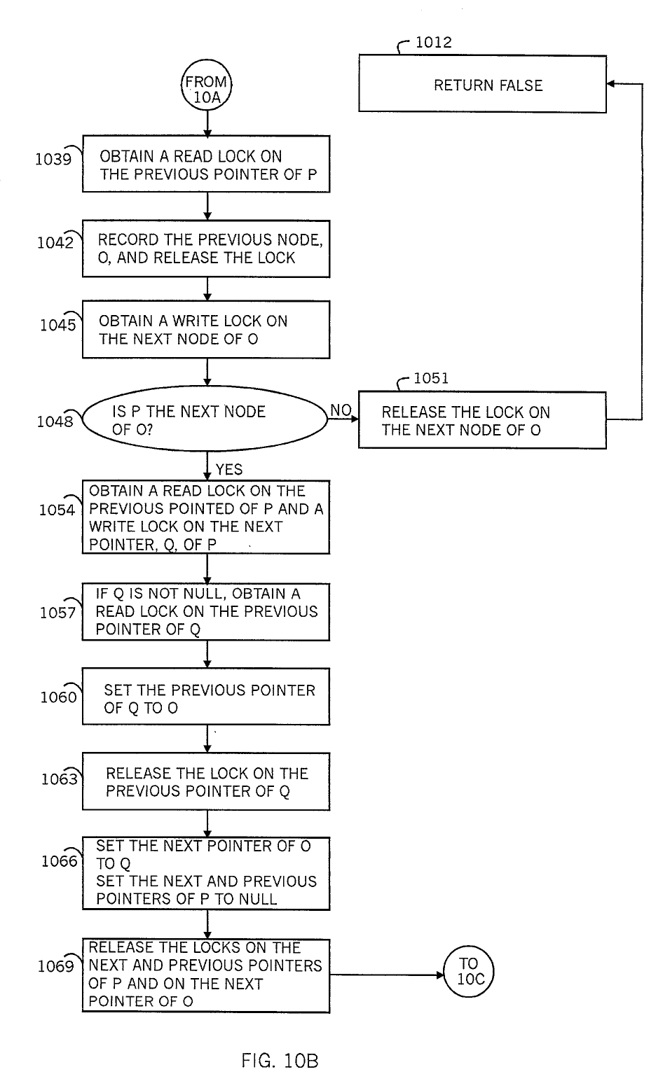

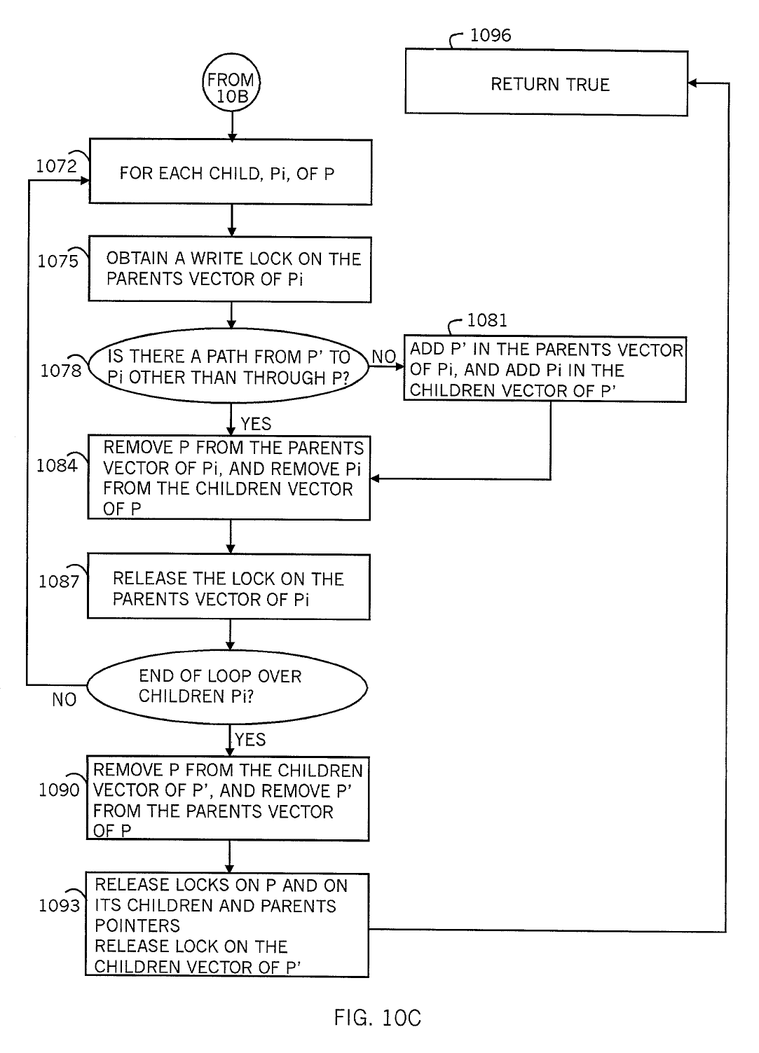

In a preferred embodiment of the present invention, the following procedure is used to delete a node from the DAG data structure, as illustrated in FIGS. 10A-10C.

Deletion of a Single Node p with One Parent p′ and Children p₁, p₂, . . .

The purpose of this procedure is to delete a single node (as distinct from destruction, which destroys a node and all of its descendants) from the data structure. From the perspective of operations on a DAG, it corresponds to the discussion of FIG. 4. The node p can be visualized as the node C in FIG. 4, for which the parent p′ is node A and the children are nodes G, H, J and K.

Obtain a read lock on the parent vector of p (step 1003).

Confirm that p has precisely one parent (step 1006). If not, release the lock (step 1009) and abandon the delete procedure (step 1012). Otherwise, record the parent, p′, and release the lock (step 1015).

Obtain a write lock on the children vector of p′ (step 1018) and confirm that it has p as a child (step 1021). If not, release the lock (step 1024), abandon the delete procedure (step 1012) and begin it again (step 1000).

Obtain a write lock on the parent vector of p (step 1027).

Confirm that p has precisely one parent, p′. If p has more than one parent (step 1030), release the lock (step 1009) and abandon the delete procedure (step 1012). If p has one parent, which is a node other than p′ (step 1033), release the lock (step 1009), abandon the delete procedure (step 1012) and begin it again (step 1000).

Obtain a write lock on p (step 1036).

Obtain a write lock on the children vector of p (step 1036).

Remove p as follows:

Obtain a read lock on the previous pointer of p (step 1039). Record the node, o, it points to and release the lock (step 1042).

Obtain a write lock on the next node of o (step 1045). If it does not point to p (step 1048) then release the lock (step 1051), abandon the delete procedure (step 1012) and begin it again (step 1000).

Obtain a read lock on the previous pointer of p (step 1054).

Obtain a write lock on the next pointer of p (step 1054). Record the node, q, it points to.

If q is not null, obtain a lock on the previous pointer of q (step 1057). Set the previous pointer of q to o (step 1060). Release the lock on the previous pointer of q (step 1063).

Set the next pointer of o to q (step 1066).

Set the next and previous pointers of p to null (step 1066).

Release the locks on the previous pointer of p, the next pointer of p and the next pointer of o (step 1069).

For each child, pi, of p (step 1072):

Obtain a write lock on the parents vector of pi (step 1075).

Check if there is a path from p′ to pᵢ other than through p; i.e., if p′ has a child other than p that contains pᵢ (step 1078). If not, add p′ in the parents vector of pᵢ and add pᵢ in the children vector of p′ (step 1081). Referring to FIG. 4, for example, there are paths from node A to nodes G and K other than through C, but there are no paths from A to nodes H and J other than through C. Therefore, links 430 are inserted from A to H and from A to J, but not from A to G nor from A to K.

Remove p from the parents vector of pᵢ, and remove pᵢ from the children vector of p (step 1084). Referring to FIG. 4, for example, links 420 from C to each of its children G, H, J and K are removed.

Release the write lock on the parents vector of pᵢ (step 1087).

Remove p from the children vector of p′, and remove p′ from the parents vector of p (step 1090). Referring to FIG. 4, for example, link 410 from A to C is removed.

Release the lock on the children vector of p′ (step 1093). Release the locks on p and on its parents and children vectors (step 1093).

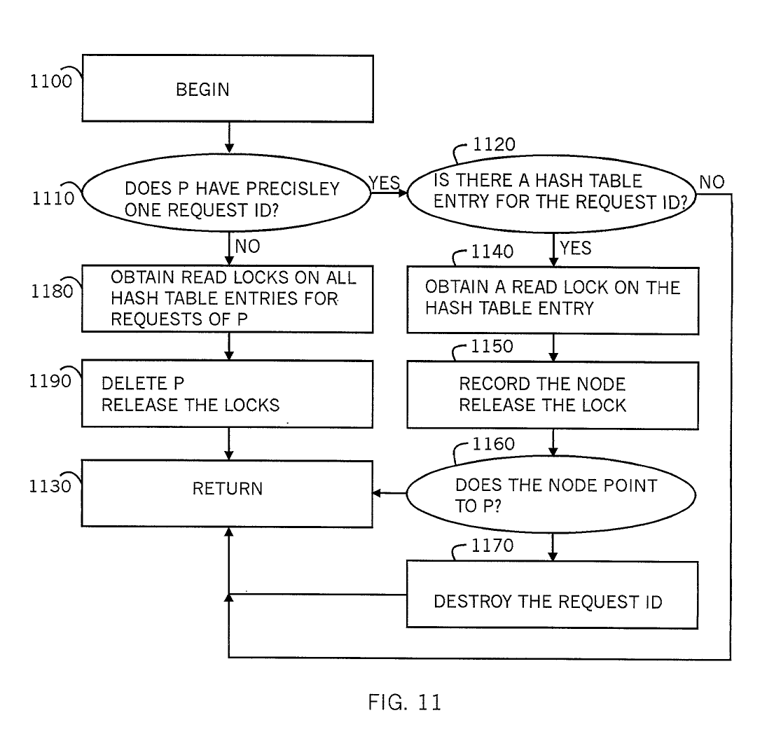

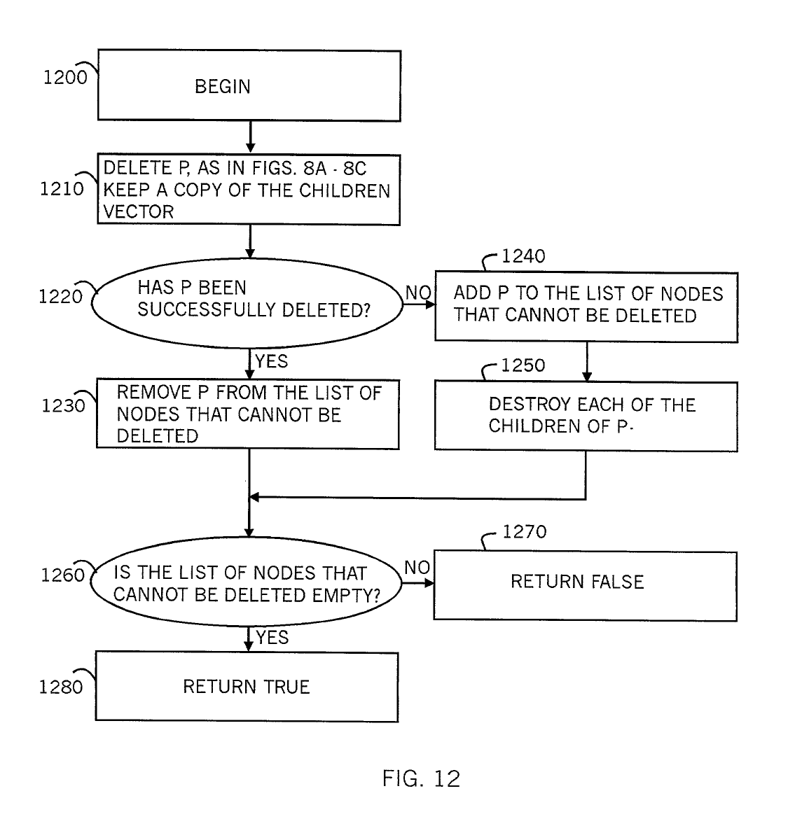

In a preferred embodiment of the present invention, the following procedure is used to delete an expired node, as illustrated in FIG. 11.

Deletion of an Expired Node

The purpose of this procedure is to delete a node that has expired.

If there is precisely one request (step 1110):

Get the hash table entry for the request ID. If there is none (step 1120), abandon the delete procedure (step 1130). Otherwise (step 1120), obtain a read lock on the request (step 1140). Record the request's node and release the read lock (step 1150).

If the request's node is not null and points to p (step 1160), destroy the request as described below (step 1170), and abandon the delete procedure (step 1130).

In all other cases (Step 1110), obtain a read lock on the hash table entries for all requests of the expired node (step 1180), delete the expired node as described above with reference to FIG. 10 and release the locks (step 1190).

In a preferred embodiment of the present invention, the following procedure is used to destroy a node, as illustrated in FIG. 12. Destruction of a node deletes the node and all of its descendants. Destruction of a node, p, is only possible when the node has a single parent, p′, and when each of its descendants has at most one parent which is not itself a descendant. This is typically the case for an original request with a unique ID. In the following procedure, a list is maintained of nodes that cannot be deleted.

Destruction of a Node, p

Delete p using the procedure described above with reference to FIG. 10, and keep a copy of the children vector (step 1210).

If p is successfully deleted (step 1220), remove any copy of p from the vector of nodes that cannot be deleted (step 1230). Otherwise, add p to the vector of undeleted nodes (step 1240), and destroy each of its children (step 1250).

At the end, if the vector of nodes that cannot be deleted is non-empty (step 1260), return false (step 1270). Otherwise, return true (step 1280).

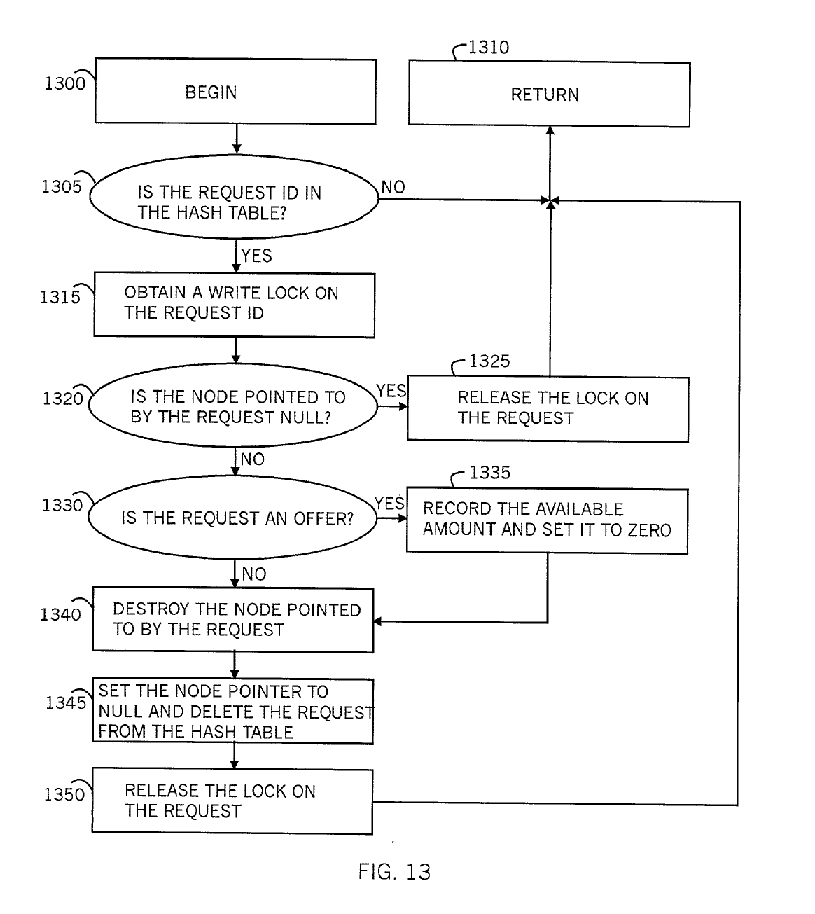

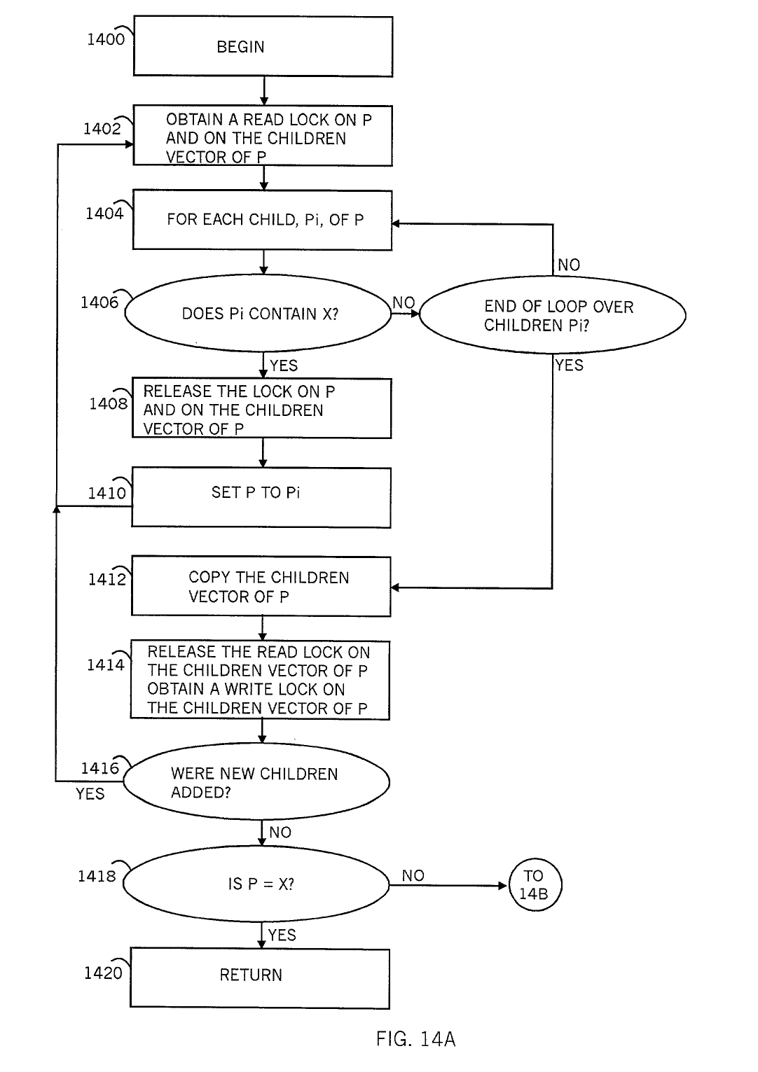

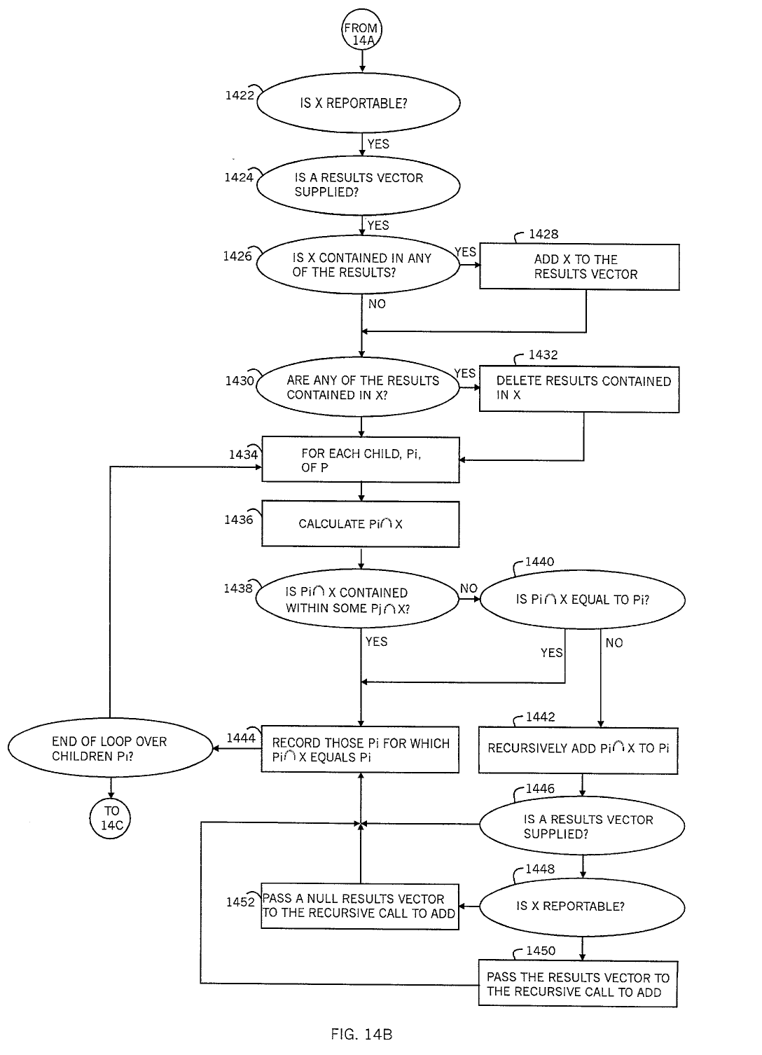

In a preferred embodiment of the present invention, the following procedure is used to destroy a request, as illustrated in FIG. 13.

Destruction of a Request

Look up the request in the request ID hash table. If it is not in the table (step 1305), abandon the destroy procedure (step 1310).

Obtain a write lock on the request (step 1315). If its node is null (step 1320), release the lock (step 1325) and abandon the destroy procedure (step 1310).

If the request is an offer (step 1330), record the “available” amount and set it to zero (step 1335).

Destroy the node pointed to by the request (step 1340).

Set its node pointer to null and delete the request from the hash table (step 1345).

Release the lock on the request (step 1350).

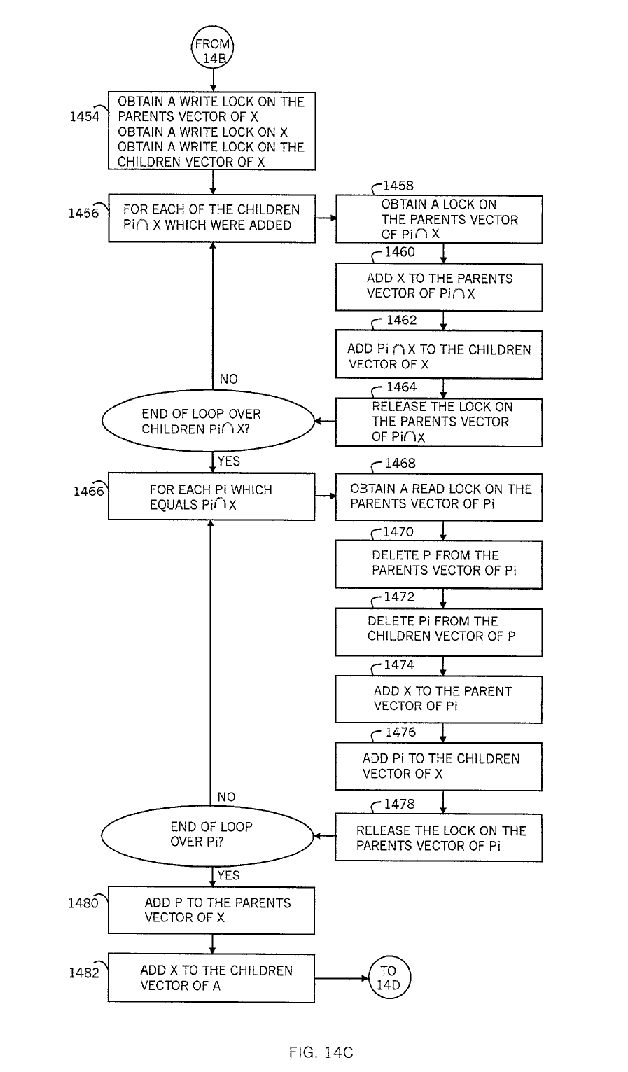

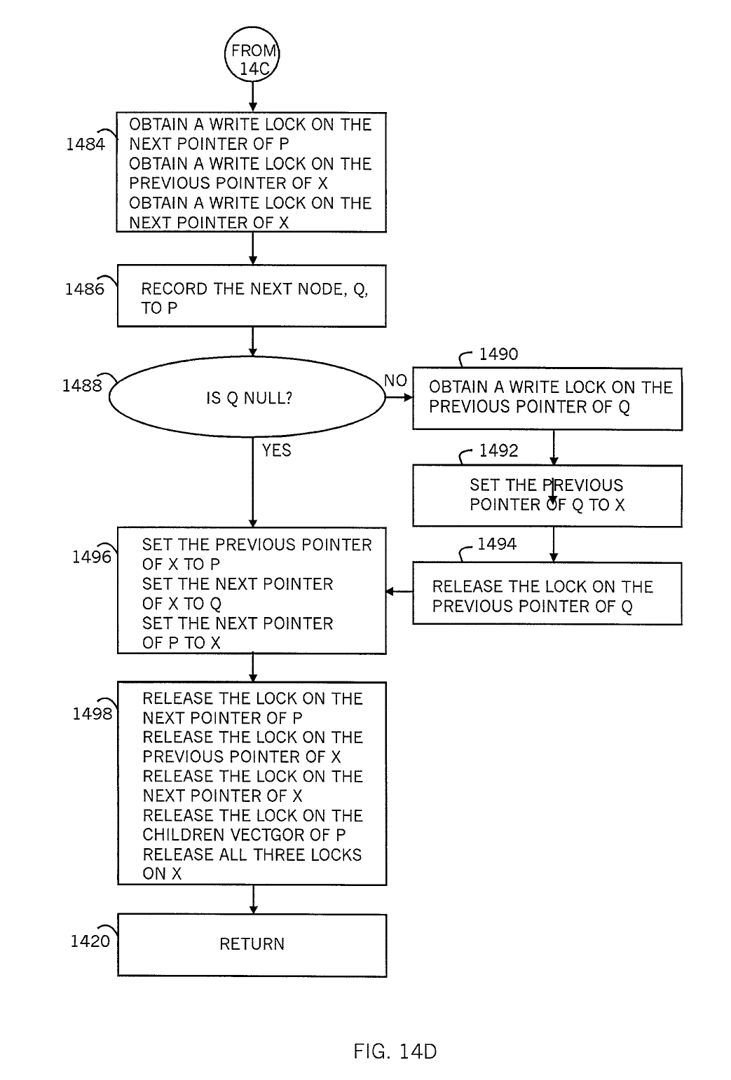

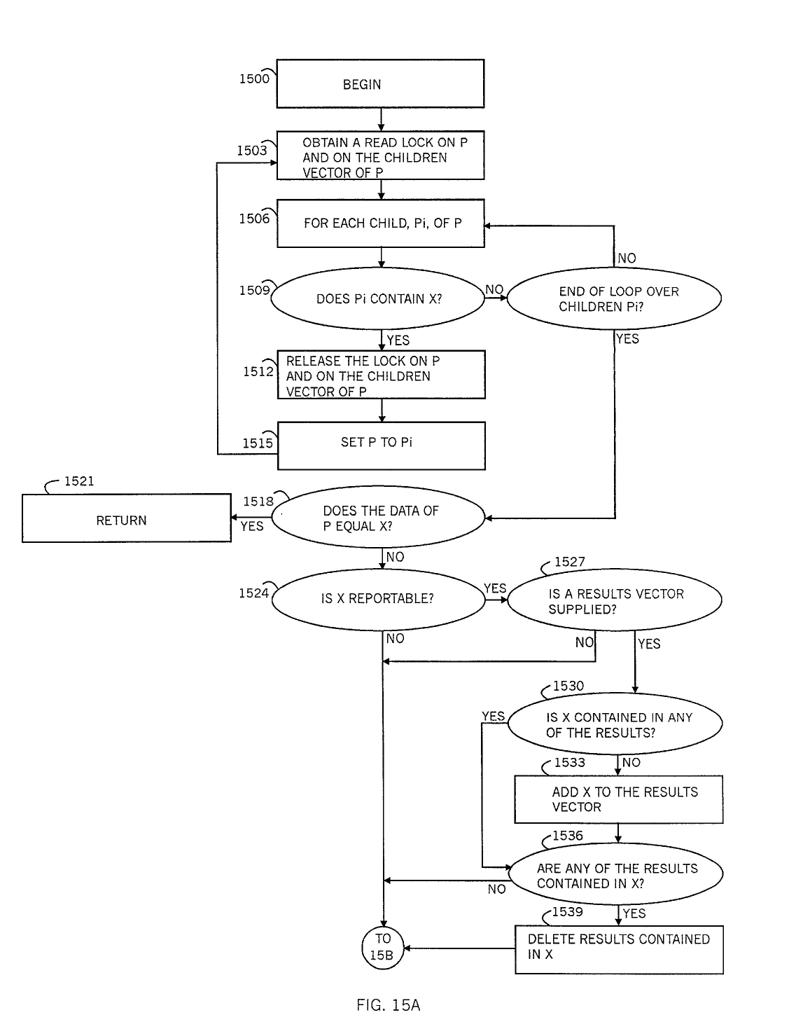

In a preferred embodiment of the present invention, the following procedure is used to add a node to the DAG data structure, as illustrated in FIGS. 14A-14D.

Addition of a Node, x, Under a Node, p (N.B., p may be the Root Element.)

The purpose of this procedure is to add a single node to the data structure. From the perspective of operations on a DAG, it corresponds to the discussion of FIG. 5. The node x can be visualized as the node X in FIG. 5.

Obtain a read lock on p and on the children vector of p (step 1402).

For each child of p (step 1404), check if it contains x (step 1406). If such a child is found, obtain a read lock on it and on its children vector (step 1402), and release the lock on p and on its children vector (step 1408). This child replaces p (step 1410), and the above steps are repeated until no such child is found. Referring to FIG. 5, for example, if node p is initially the root node A, then after one iteration p is replaced by the child, D, of A, since D contains X. Since none of the children of D contain X, no further replacements of p occur, and p remains node D throughout the rest of the procedure.

Copy the children vector of p (step 1412). Release the lock on the children vector and obtain a write lock (Step 1414). Check if any new children were added (step 1416). If so, repeat the above steps again.

Check if p=x (step 1418). If so, the procedure is finished (step 1420). Otherwise, continue.

If x is reportable (step 1422) and if a results vector is supplied (step 1424), check if x is contained in any of the nodes in the results vector (step 1426) and, if not, add it to the results vector (step 1428). Check if any nodes in the results vector are contained in x (step 1430) and, if so, delete them (step 1432).

For each child, pᵢ, of p (step 1434), calculate the intersection p₁∩x (step 1436). Referring to FIG. 5, for example, the children of D are H, I, J and K. Thus four intersections are calculated; namely, X∩H, X∩I, X∩j and X∩K.

Recursively add pᵢ∩x under pᵢ (step 1442), unless it is a subset of some other intersection pⱼ∩x (step 1438), or unless it equals pᵢ (step 1440). Record those pi which equal pᵢ∩x (step 1444). Pass the results vector to the recursive calls (step 1452) if one is supplied (step 1446), unless x is reportable (step 1448), in which case pass a null pointer (step 1452). Referring to FIG. 5, for example, X∩H is added under H, and X∩I is added under I. Since J and K are subsets of X, X∩J=J and X∩K=K. Therefore, these latter intersections are not added under J and K, respectively.

Obtain write locks on the parents vector of x, then on x and then on the children vector of x (step 1454).

For each of the pᵢ∩x that were added (step 1456):

Obtain a read lock on the parents vector of pᵢ∩x (step 1458).

Add x to its parents vector (step 1460) and add pᵢ∩x to the children vector of x (step 1462). Referring to FIG. 5, for example, links 550 are added from X to X∩H and from X to X∩I.

Release the lock on the parents vector of pᵢ∩x (step 1464).

For each pᵢ that equals pᵢ∩x (step 1466):

Obtain a read lock on the parents vector of pᵢ (step 1468).

Delete p from its parents vector (step 1470) and delete pᵢ from the children vector of p (step 1472). Referring to FIG. 5, for example, links 520 from D to J and from D to K are removed.

Add x to its parents vector (step 1474) and add pᵢ∩x to the children vector of x (step 1476). Referring to FIG. 5, for example, links 530 from X to J and from X to K are added.

Release the lock on the parents vector of pᵢ (step 1478).

Add p to the parents vector of x (step 1480), and add x to the children vector of p (step 1482). Referring to FIG. 5, link 510 is added from D to X.

Obtain a write lock on the next pointer of p. Obtain a read lock on the previous pointer of x. Obtain a write lock on the next pointer of x (step 1484).

Record the next node, q, to p (step 1486).

If q is not null (step 1488), obtain a lock on its previous pointer (step 1490). Set the previous pointer of q to x (step 1492). Release the lock on the previous pointer of q (step 1494).

Set the previous pointer of x to p and its next pointer to q, and set the next pointer of p to x (step 1496).

Release the locks on the next pointer of p, and on the previous and next pointers of x (step 1498).

Release the locks on the children vector of p and all three locks on x (step 1498).

It will be noted that an add node procedure with less locking can be accomplished by obtaining locks on the children vector of x only after adding the pᵢ∩x. However, in this case it is necessary to check that no further children have been added to p. If new children have been added to p, then the intersection of x with the new children must be added before trying again. If new children have been added to p, it is also necessary to check whether one of them contains x, in which case x should not be added under p as it will already be added under the children.

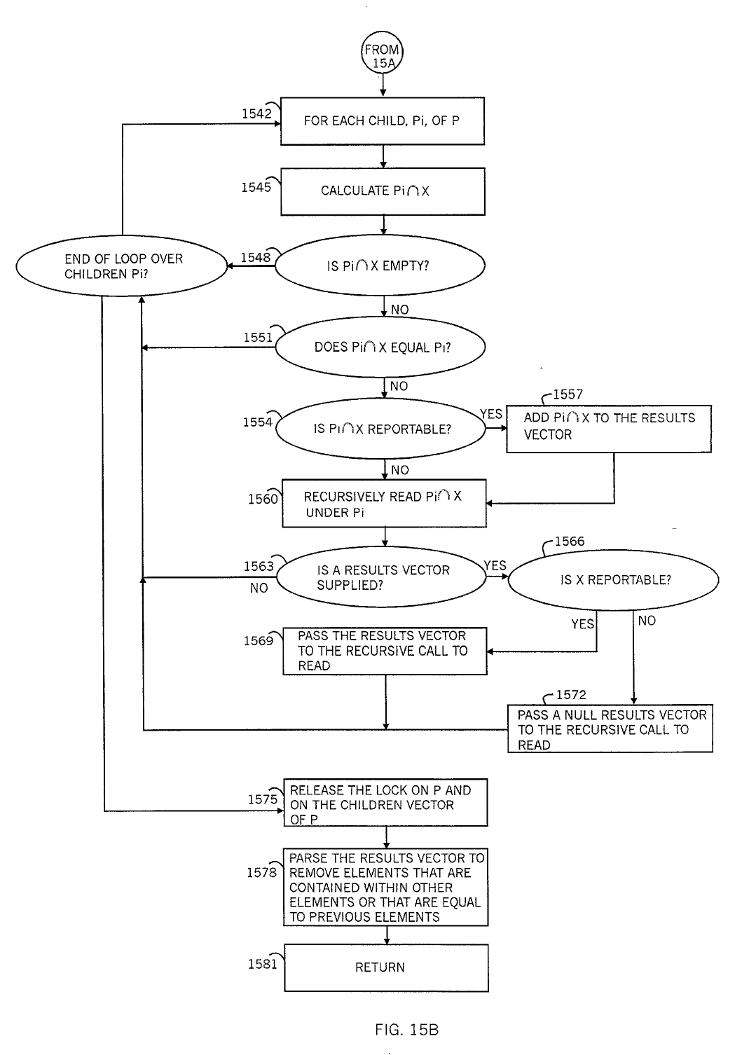

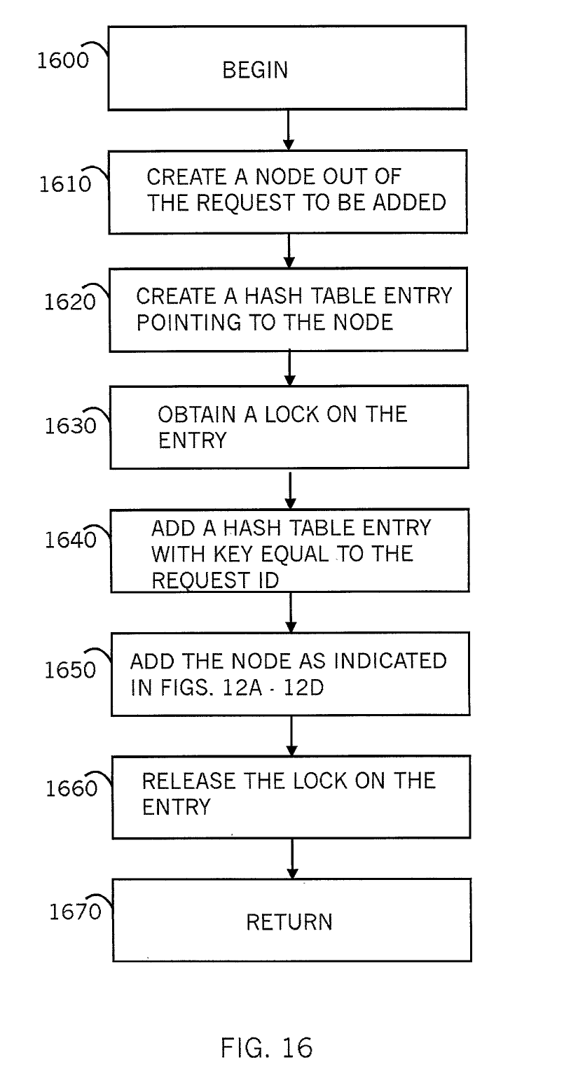

In a preferred embodiment of the present invention, the following procedure is used to process a read-only request, as illustrated in FIGS. 15A and 15B.

Reading an XPL, x, Under a Node, p (N.B., p may be the Root Element.)

This procedure receives an XPL, x, and a reporting vector, and adds to the vector all of the new reportable intersections enabled by x, which are not contained in other new reportable intersections. No new nodes are created by this procedure.

Obtain a read lock on p and on the children vector of p (step 1503).

For each child of p (step 1506), check if it contains x (step 1509). If such a child is found, obtain a read lock on it and on its children vector (step 1503), and release the lock on p and on its children vector (step 1512). This child replaces p (step 1515), and the above steps are repeated until no such child is found.

If the data of p equals x (step 1518), abandon the read procedure (step 1521).

If x is reportable (step 1524) and if a results vector is supplied (step 1527), check if x is contained in any of the results vector (step 1530) and, if not, add it to the results vector (step 1533). Check if any of the results vector are contained in x (step 1536) and, if so, delete them (step 1539).

For each child, pᵢ, of p (step 1542) calculate the intersection pᵢ∩x (step 1545). If pᵢ∩x is non-empty (step 1548) and is not equal to pᵢ (step 1551), check if it is reportable (step 1554). If it is, add it to the results vector (step 1557). If not, recursively read pᵢ∩x under pᵢ (step 1560). Pass the results vector to each recursive call (step 1569), if a results vector is supplied (step 1563), unless x is reportable (step 1566), in which case pass a null pointer (step 1572).

Release the lock on p and on the children vector of p (step 1575).

Parse the results vector to remove elements that are contained in other elements or which are equal to previously recorded elements (step 1578).

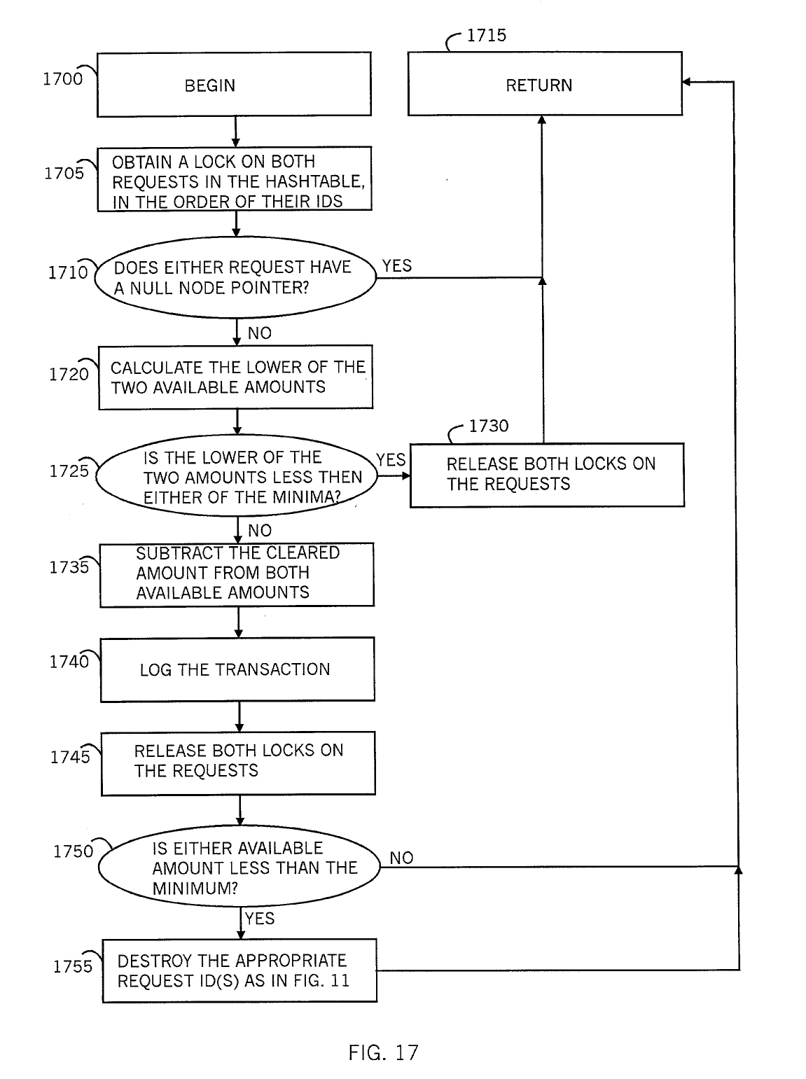

In a preferred embodiment of the present invention, the following procedure is used to add a request, as illustrated in FIG. 16.

Addition of a Request

Create a node for the new request (step 1610).

Create a hash table entry pointing to the node (step 1620) and obtain a lock on the request entry (step 1630).

Add an entry to the hash table with a key equal to the request ID (step 1640).

Add the node to the data structure as above (step 1650).

Release the lock on the hash table entry (step 1660).

In a preferred embodiment of the present invention, the following procedure is used to clear offers, as illustrated in FIG. 17.

Clearing Two Offers

Obtain a read lock on both requests in the hash table in order of their IDs (step 1705).

Check if either request has a null node pointer (step 1710). If so, abandon the clear procedure (step 1715).

Calculate the smaller of the two available amounts (step 1720). This will be the cleared amount. If this is less than either of the minima (step 1725), then release the locks (step 1730) and abandon the clear procedure (step 1715).

Subtract the cleared amount from both available amounts (step 1735). Note whether either available amount is now less than the corresponding minimum.

Log the transaction (step 1740).

Release both locks (step 1745).

If either amount is less than the minimum (step 1750), destroy the request as described above with reference to FIG. 13 (step 1755).

In reading the above description, persons skilled in the art will realize that there are many apparent variations that can be applied to the methods and systems described. Although the present invention has been described for use in matching transaction descriptions, it has many other uses. For example, it can be used for matching of security profiles.

It will be appreciated by persons skilled in the art that the present invention is not limited by what has been particularly shown and described hereinabove. Rather the present invention includes combinations and sub-combinations of the various features described hereinabove as well as modifications and extensions thereof which would occur to a person skilled in the art and which do not fall within the prior art.

### Appendix A

Attached is a sample XPL document for a buyer transaction description.

<automobile-sale>

<P1>

<xpl: choice value1=“Ford” value2=“Chevrolet”/>

</P1>
<P2>

<xpl: choice value1=“1998” value2=“1999” value3=“2000”/>

</P2>
<P3>

<xpl: choice value1=“Black” value2=“Blue”/>

</P3>
<P4>

<xpl: range min=“0” max =“15000”/>

</P4>
<P5>

<xpl: daterange prefer=“down”>

<date>

<year>

2000

</year>
<month>

11

</month>
<day>

1

</day>

</date>
<date>

<year>

2000

</year>
<month>

11

</month>
<day>

15

</day>

</date>

</xpl daterange>

</P5>
<P6>

<buyer>

<name>

Auto Industries

</name>
<state>

CA
</state>

</buyer>
<seller>

<name>

<xpl: any-element>

</name>
<state>

CA

</state>

</seller>

</P6>

</automobile-sale>

What is claimed is:

1. A method for analyzing a plurality of sets of elements, and identifying which sets from among the plurality of sets have elements in common with a trial set, comprising:
storing a plurality of sets;
arranging the stored plurality of sets according to a directed graph data structure, the directed graph including nodes that correspond to sets and including directed edges that correspond to a relationship of set-wise inclusion;
for a given trial set, denoted T, finding, within the directed graph, a smallest set, denoted S, that contains T; and
determining whether T has a non-empty intersection with sets of the directed graph that are contained within S.

2. The method of claim 1 wherein the sets include data for transaction descriptions that describe at least one transaction, and the elements correspond to individual transactions.

3. The method of claim 2 wherein the transaction descriptions include buyer transaction descriptions and seller transaction descriptions.

4. The method of claim 3 wherein the transaction descriptions include transaction descriptions for additional parties.

5. The method of claim 2 wherein the transaction descriptions include flexible parameters for commercial transactions.

6. The method of claim 2 wherein the transaction descriptions contain a plurality of tags for specifying transaction parameters, and wherein at least one of the tags is used to specify more than one value for a transaction parameter.

7. The method of claim 6 wherein the transaction descriptions contain a product tag.

8. The method of claim 6 wherein the transaction descriptions contain a price tag.

9. The method of claim 6 wherein the transaction descriptions contain a place tag.

10. The method of claim 6 wherein the transaction descriptions contain a date tag.

11. The method of claim 6 wherein the transaction descriptions include buyer transaction descriptions, and wherein each buyer transaction description contains a buyer tag and a seller tag.

12. The method of claim 11 wherein the buyer tag for a buyer transaction description specifies a single buyer.

13. The method of claim 11 wherein the seller tag for a buyer transaction description specifies a multiplicity of sellers.

14. The method of claim 6 wherein the transaction descriptions include buyer transaction descriptions, and wherein each seller transaction description contains a buyer tag and a seller tag.

15. The method of claim 14 wherein the seller tag for a seller transaction description specifies a single seller.

16. The method of claim 14 wherein the buyer tag for a seller transaction description specifies a multiplicity of buyers.

17. The method of claim 2 further comprising augmenting the directed graph with nodes that correspond to non-empty intersections of sets from the stored plurality of sets.

18. The method of claim 2 wherein the directed graph is irredundant, so that no two distinct nodes correspond to the same set.

19. The method of claim 2 wherein the directed graph is such that sets corresponding to child nodes of the same node are not included set-wise one within another.

20. The method of claim 2 wherein the directed graph is closed under set-wise intersection, so that a non-empty intersection of any two sets in the directed graph is itself a set in the directed graph.

21. The method of claim 2 further comprising:
storing the given trial set, T; and
adding T to the directed graph.

22. The method of claim 21 wherein said adding the given trial set, T, comprises:
adding an edge from S to T;
determining which child sets of S are also subsets of T;
for each child set, denoted C₁, of S that is also a subset of T:
deleting from the directed graph an edge from S to C₁; and
adding to the directed graph an edge from T to C₁; and
for each child set, denoted C₂, of S that is not a subset of T and that has a non-empty intersection with T:
adding to the directed graph a new node corresponding to the intersection of T with C₂; and
adding to the directed graph a first edge from T to the new node and a second edge from C₂ to the new node.

23. The method of claim 21 wherein said adding T is performed when there are no sets from among the stored plurality of sets that have elements in common with T.

24. The method of claim 2 further comprising deleting a selected set having a single parent set from the directed graph.

25. The method of claim 24 wherein said deleting a selected set having a single parent set comprises:
deleting an edge from the single parent set of the selected set to the selected set;
deleting edges from the selected set to child sets of the selected set; and
adding edges from the single parent of the selected set to those child sets of the selected set which are not children of any child set of the single parent set other than the selected set.

26. The method of claim 24 wherein the selected set is one of the stored plurality of sets that has a non-empty intersection with the given trial set, T.

27. The method of claim 2 wherein the stored plurality of sets are stored in a database.

28. The method of claim 27 wherein the database is a relational database.

29. The method of claim 27 wherein the database is an object database.

30. The method of claim 1 further comprising generating additional nodes in order to combine nodes in the directed graph and thereby reduce the number of branches stemming from a given node.

31. A system for analyzing a plurality of sets of elements, and identifying which sets from among the plurality of sets have elements in common with a trial set, comprising:
a memory storing a plurality of sets;
a data manager arranging the stored plurality of sets according to a directed graph data structure, the directed graph including nodes that correspond to sets and including directed edges that correspond to a relationship of set-wise inclusion;
a set analyzer finding, for a given trial set, denoted T, a smallest set, denoted S, within the directed graph that contains T, and determining whether T has a non-empty intersection with sets of the directed graph that are contained within S.

32. The system of claim 31 wherein the sets include data for transaction descriptions that describe at least one transaction, and the elements correspond to individual transactions.

33. The system of claim 32 wherein the transaction descriptions include buyer transaction descriptions and seller transaction descriptions.

34. The system of claim 33 wherein the transaction descriptions include transaction descriptions for additional parties.

35. The system of claim 32 wherein the transaction descriptions include flexible parameters for commercial transactions.

36. The system of claim 32 wherein the transaction descriptions contain a plurality of tags for specifying transaction parameters, and wherein at least one of the tags is used to specify more than one value for a transaction parameter.

37. The system of claim 36 wherein the transaction descriptions contain a product tag.

38. The system of claim 36 wherein the transaction descriptions contain a price tag.

39. The system of claim 36 wherein the transaction descriptions contain a place tag.

40. The system of claim 36 wherein the transaction descriptions contain a date tag.

41. The system of claim 36 wherein the transaction descriptions include buyer transaction descriptions, and wherein each buyer transaction description contains a buyer tag and a seller tag.

42. The system of claim 41 wherein the buyer tag for a buyer transaction description specifies a single buyer.

43. The system of claim 41 wherein the seller tag for a buyer transaction description specifies a multiplicity of sellers.

44. The system of claim 36 wherein the transaction descriptions include buyer transaction descriptions, and wherein each seller transaction description contains a buyer tag and a seller tag.

45. The system of claim 44 wherein the seller tag for a seller transaction description specifies a single seller.

46. The system of claim 44 wherein the buyer tag for a seller transaction description specifies a multiplicity of buyers.

47. The system of claim 32 wherein said set analyzer augments the directed graph with nodes that correspond to non-empty intersections of sets from the stored plurality of sets.

48. The system of claim 32 wherein the directed graph is irredundant, so that no two distinct nodes correspond to the same set.

49. The system of claim 32 wherein the directed graph is such that sets corresponding to child nodes of the same node are not contained one within another.

50. The system of claim 32 wherein the directed graph is closed under set-wise intersection, so that a non-empty intersection of any two sets in the directed graph is itself a set in the directed graph.

51. The system of claim 32 wherein said data manager stores the given trial set, T, and adds T to the directed graph.

52. The system of claim 51 wherein said data manager:
adds an edge from S to T;
determines which child sets of S are also subsets of T;
for each child set, denoted C₁, of S that is also a subset of T:
deletes from the directed graph an edge from S to C₁; and
adds to the directed graph an edge from T to C₁; and
for each child set, denoted C₂, of S that is not a subset of T and that has a non-empty intersection with T:
adds to the directed graph a new node corresponding to the intersection of T with C₂; and
adds to the directed graph a first edge from T to the new node and a second edge from C₂ to the new node.

53. The system of claim 51 wherein said data manager adds T to the directed graph when there are no sets from among the stored plurality of sets that have elements in common with T.

54. The system of claim 32 wherein said data manager deletes a selected set having a single parent set from the directed graph.

55. The system of claim 54 wherein said data manager:
deletes an edge from the single parent set of the selected set to the selected set;
deletes edges from the selected set to child sets of the selected set; and
adds edges from the single parent of the selected set to those child sets of the selected set which are not children of any child set of the single parent set other than the selected set.

56. The system of claim 54 wherein the selected set is one of the stored plurality of sets that has a non-empty intersection with the given trial set, T.

57. The system of claim 32 wherein the stored plurality of sets are stored in a database.

58. The system of claim 57 wherein the database is a relational database.

59. The system of claim 57 wherein the database is an object database.

60. The system of claim 31 further comprising generating additional nodes in order to combine nodes in the directed graph and thereby reduce the number of branches stemming from a given node.

61. A method for analyzing a plurality of transaction descriptions having parameters for describing at least one transaction, and determining which transaction descriptions from the plurality of transaction descriptions overlap with a trial transaction description, comprising:
storing a plurality of transaction descriptions having flexible parameters for commercial transactions;
selecting a primary parameter from among the flexible parameters;
organizing the stored plurality of transaction descriptions in terms of the primary parameter;
for a given trial transaction description, denoted T, finding a primary subset of transaction descriptions from among the stored plurality of transaction descriptions that overlap with T with respect to values of the primary parameter; and
identifying the transaction descriptions from among the primary subset of transaction descriptions that overlap with T.

62. The method of claim 61 wherein the transaction descriptions include buyer transaction descriptions and seller transaction descriptions.

63. The method of claim 62 wherein the transaction descriptions include transaction descriptions for additional parties.

64. The method of claim 61 wherein said organizing organizes the plurality of transaction descriptions into a binary search tree data structure, based on the primary parameter.

65. The method of claim 61 wherein the primary parameter is a range delimiter for a range of values.

66. The method of claim 61 further comprising:
further selecting a secondary parameter from among the flexible parameters, distinct from the primary parameter;
further organizing the stored plurality of transaction descriptions in terms of the secondary parameter; and
finding a secondary subset of transaction descriptions from among the primary subset of transaction descriptions that overlap with T with respect to values of the secondary parameter,
wherein said identifying determines whether T overlaps with the transaction descriptions from among the secondary subset of transaction descriptions.

67. The method of claim 66 wherein said further organizing organizes the plurality of transaction descriptions into a binary search tree data structure, based on the secondary parameter.

68. The method of claim 66 wherein the secondary parameter is a range delimiter for a range of values.

69. A system for analyzing a plurality of transaction descriptions having parameters for describing at least one transaction, and determining which transaction descriptions from the plurality of transaction descriptions overlap with a trial transaction description, comprising:
a memory storing a plurality of transaction descriptions having flexible parameters for commercial transactions;
a parameter selector selecting a primary parameter from among the flexible parameters;
a data manager organizing the stored plurality of transaction descriptions in terms of the primary parameter; and
a transaction description analyzer finding, for a given trial transaction description, denoted T, a primary subset of transaction descriptions from among the stored plurality of transaction descriptions that overlap with T with respect to values of the primary parameter, and identifying the transaction descriptions from among the primary subset of transaction descriptions that overlap with T.

70. The system of claim 69 wherein the transaction descriptions include buyer transaction descriptions and seller transaction descriptions.

71. The system of claim 70 wherein the transaction descriptions include transaction descriptions for additional parties.

72. The system of claim 69 wherein said data manager organizes the plurality of transaction descriptions into a binary search tree data structure, based on the primary parameter.

73. The system of claim 69 wherein the primary parameter is a range delimiter for a range of values.

74. The system of claim 69 wherein said parameter selector further selects a secondary parameter from among the flexible parameters, distinct from the primary parameter, and wherein said data manager further organizes the stored plurality of transaction descriptions in terms of the secondary parameter, and wherein said transaction description analyzer further finds a secondary subset of transaction descriptions from among the primary subset of transaction descriptions that overlap with T with respect to values of the secondary parameter, and determines whether T overlaps with the transaction descriptions from among the secondary subset of transaction descriptions.

75. The system of claim 74 wherein said data manager organizes the plurality of transaction descriptions into a binary search tree data structure, based on the secondary parameter.

76. The system of claim 74 wherein the secondary parameter is a range delimiter for a range of values.

77. A method for analyzing a plurality of transaction descriptions, comprising:
storing a plurality of sets, wherein the sets include data for transaction descriptions that describe at least one transaction, and the elements correspond to individual transactions;
arranging the stored plurality of sets according to a directed graph data structure, the directed graph including nodes that correspond to sets and including directed edges that correspond to a relationship of set-wise inclusion; and
applying a data locking mechanism to the nodes of the directed graph, for processes to lock and unlock data included within the nodes, wherein a lock on any ancestor of a node precedes a lock on the node itself.

78. The method of claim 77 wherein said applying applies simple locks, which prevent any process other than a process applying a lock to a node, from reading or writing data within the node.

79. The method of claim 77 wherein said applying applies write locks, which prevent any process other than a process applying a lock to a node, from writing data within the node, but permit them to read data within the node.

80. The method of claim 77 wherein each node is augmented with a list of parents and with a list of children, and wherein a lock on the list of parents precedes a lock on the node, and the lock on the node precedes a lock on the list of children.

81. A system for analyzing a plurality of transaction descriptions, comprising:
a memory storing a plurality of sets, wherein the sets include data for transaction descriptions that describe at least one transaction, and the elements correspond to individual transactions;
a data manager arranging the stored plurality of sets according to a directed graph data structure, the directed graph including nodes that correspond to sets and including directed edges that correspond to a relationship of set-wise inclusion; and
a data locking mechanism enabling processes to lock and unlock data included within the nodes of the directed graph, wherein a lock on any ancestor of a node precedes a lock on the node itself.

82. The system of claim 81 wherein said data locking mechanism employs simple locks, which prevent any process other than a process applying a lock to a node, from reading or writing data within the node.

83. The system of claim 81 wherein said data locking mechanism employs write locks, which prevent any process other than a process applying a lock to a node, from writing data within the node, but permit them to read data within the node.

84. The system of claim 81 wherein each node is augmented with a list of parents and with a list of children, and wherein a lock on the list of parents precedes a lock on the node, and the lock on the node precedes a lock on the list of children.

85. A method for analyzing database records, comprising:
providing a database for storing a plurality of records, at least one record having at least one field that contains sets of values; and
for a given query that specifies at least one set of values corresponding to at least one field, identifying the records from among the plurality of records in the database whose fields contain sets that have non-empty intersection with corresponding sets in the query.

86. The method of claim 85 wherein the database is a relational database.

87. The method of claim 85 wherein the database is an object database.

88. The method of claim 85 wherein at least one set of values is an interval range.

89. The method of claim 88 wherein the interval range is of the form x>A.

90. The method of claim 89 wherein an interval range of the form x>A is represented internally in the database by a parameter for the delimiter A, and a parameter for a symbol <, = and >.

91. The method of claim 88 wherein the interval range is of the form x<B.

92. The method of claim 91 wherein an interval range of the form x<B is represented internally in the database by a parameter for the delimiter B, and a parameter for a symbol <, = and >.

93. The method of claim 88 wherein the interval range is of the form A<x<B.

94. The method of claim 93 wherein an interval range of the form A<x<B is represented internally in the database by parameters for the delimiters A and B, and a parameter for a symbol <, = and >.

95. The method of claim 85 further comprising:
representing fields having sets of values therein as at least one field having single values therein; and
converting the given query into an equivalent query in terms of the fields having single values therein.

96. The method of claim 95 further comprising employing a conventional database query processor to respond to the equivalent query.

97. A system for analyzing database records, comprising:
a database for storing a plurality of records, at least one record having at least one field that contains sets of values; and
a query processor identifying, for a given query that specifies at least one set of values corresponding to at least one field, the records from among the plurality of records in the database whose fields contain sets that have non-empty intersection with corresponding sets in the query.

98. The system of claim 97 wherein the database is a relational database.

99. The system of claim 97 wherein the database is an object database.

100. The system of claim 97 wherein at least one set of values is an interval range.

101. The system of claim 100 wherein the interval range is of the form x>A.

102. The system of claim 101 wherein an interval range of the form x>A is represented internally in the database by a parameter for the delimiter A, and a parameter for a symbol <, = and >.

103. The system of claim 100 wherein the interval range is of the form x<B.

104. The system of claim 103 wherein an interval range of the form x<B is represented internally in the database by a parameter for the delimiter B, and a parameter for a symbol <, = and >.

105. The system of claim 100 wherein the interval range is of the form A<x<B.

106. The system of claim 1 OS wherein an interval range of the form A<X<B is represented internally in the database by parameters for the delimiters A and B, and a parameter for a symbol <, = and >.

107. The system of claim 97 further comprising:
a record converter representing fields having sets of values therein as at least one field having single values therein; and
a query converter converting the given query into an equivalent query in terms of the fields having single values therein.

108. The system of claim 107 further comprising a conventional database query processor responding to the equivalent query.

109. A method for analyzing a plurality of transaction descriptions, comprising:
receiving a plurality of submitted user requests, wherein a user request includes a request type, a request owner, and a transaction description having flexible parameters and corresponding to a set of individual transactions; and
storing the user requests according to a directed graph data structure, the directed graph including nodes that correspond to user requests and including directed edges that correspond to a relationship of set-wise inclusion.

110. The method of claim 109 wherein the user requests include a request ID, the method further comprising organizing the user requests within a hash table using the request IDs.

111. The method of claim 109 wherein a request type includes a search or an offer.

112. The method of claim 111 wherein an offer includes a non-binding offer or a binding offer.

113. The method of claim 109 further comprising constructing parents vectors and children vectors for nodes in the directed graph, wherein the parents vector of a given node lists parent nodes of the given node, and the children vector of a given node lists child nodes of the given node.

114. The method of claim 109 further comprising:
ordering nodes of the directed graph in a linear order; and
correspondingly associating previous pointers and next pointers with nodes in the directed graph.

115. The method of claim 109 further comprising adding a new node to the directed graph when a new user request is submitted.

116. The method of claim 109 further comprising removing a node from the directed graph when a user request is withdrawn.

117. The method of claim 109 further comprising modifying the directed graph when a user request is modified.

118. The method of claim 109 wherein a user request includes an expiration date.

119. The method of claim 118 further comprising removing a node from the directed graph when a user request expires.

120. The method of claim 109 further comprising augmenting the directed graph with a root node and outgoing edges therefrom.

121. The method of claim 120 further comprising augmenting the directed graph with additional nodes and directed edges, the additional nodes corresponding to finite intersections of user requests and the additional directed edges corresponding to a relationship of set-wise inclusion.

122. The method of claim 121 further comprising augmenting the directed graph with additional nodes and edges, as appropriate, in order to reduce the number of outgoing edges emanating from a single node.

123. The method of claim 109 further comprising matching a submitted user request with the stored user requests to identify stored user requests that are compatible with the submitted user request, by analyzing the directed graph.

124. The method of claim 123 further comprising maintaining, for each user request, a results vector including a list of other user requests that are compatible therewith.

125. The method of claim 124 further comprising updating the results vectors when additional user requests are submitted.

126. The method of claim 124 further comprising updating the results vectors when user requests are modified.

127. The method of claim 124 further comprising notifying the owner of a user request of the results vector for the user request.

128. A system for analyzing a plurality of transaction descriptions, comprising:
a user interface receiving a plurality of submitted user requests, wherein a user request includes a request type, a request owner, and a transaction description having flexible parameters and corresponding to a set of individual transactions; and
a data organizer storing the user requests according to a directed graph data structure, the directed graph including nodes that correspond to user requests and including directed edges that correspond to a relationship of set-wise inclusion.

129. The system of claim 128 wherein the user requests include a request ID, and wherein the data organizer organizes the user requests within a hash table using the request IDs.

130. The system of claim 128 wherein a request type includes a search or an offer.

131. The system of claim 130 wherein an offer includes a non-binding offer or a binding offer.

132. The system of claim 128 wherein said data organizer constructs parents vectors and children vectors for nodes in the directed graph, the parents vector of a given node listing parent nodes of the given node, and the children vector of a given node listing child nodes of the given node.

133. The system of claim 128 wherein said data organizer orders nodes of the directed graph in a linear order, and correspondingly associates previous pointers and next pointers with nodes in the directed graph.

134. The system of claim 128 further comprising a data manager adding a new node to the directed graph when a new user request is submitted.

135. The system of claim 128 further comprising a data manager removing a node from the directed graph when a user request is withdrawn.

136. The system of claim 128 further comprising a data manager modifying the directed graph when a user request is modified.

137. The system of claim 128 wherein a user request includes an expiration date.

138. The system of claim 137 further comprising a data manager removing a node from the directed graph when a user request expires.

139. The system of claim 128 further comprising a data manager augmenting the directed graph with a root node and outgoing edges therefrom.

140. The system of claim 139 wherein said data manager augments the directed graph with additional nodes and directed edges, the additional nodes corresponding to finite intersections of user requests and the additional directed edges corresponding to a relationship of set-wise inclusion.

141. The system of claim 140 wherein said data manager augments the directed graph with additional nodes and edges, as appropriate, in order to reduce the number of outgoing edges emanating from a single node.

142. The system of claim 128 further comprising a data matcher matching a submitted user request with the stored user requests to identify stored user requests that are compatible with the submitted user request, by analyzing the directed graph.

143. The system of claim 142 comprising a results manager maintaining, for each user request, a results vector including a list of other user requests that are compatible therewith.

144. The system of claim 143 wherein said results manager updates the results vectors when additional user requests are submitted.

145. The system of claim 143 wherein said results manager updates the results vectors when user requests are modified.

146. The system of claim 143 further comprising a notification manager notifying the owner of a user request of the results vector for the user request.
